(19) United States
(12) Patent Application Publication
(10) Pub. No.: US 2012/0095817 A1
(43) Pub. Date: Apr. 19, 2012

(54) DEVICE, SYSTEM, AND METHOD OF GENERATING A MULTIMEDIA PRESENTATION

(76) Inventors: Assaf Moshe Kamil, Hod-Hasharon (IL); Avihai Dov Schieber, Even Yehuda (IL)

(21) Appl. No.: 13/378,075

(22) PCT Filed: Jun. 17, 2010
(86) PCT No.: PCT/IB10/52740

§ 371 Date: Dec. 14, 2011

Related U.S. Application Data
(60) Provisional application No. 61/218,083, filed on Jun. 18, 2009.

(51) Int. Cl. G06F 17/00; G06Q 30/02

(52) U.S. Cl. 705/14.4; 715/202

(57) ABSTRACT

Devices, systems, and methods of generating a multimedia presentation. Some embodiments, may include a presentation-generation application able to receive a plurality of input media elements and to generate a multimedia presentation including at least one presentation segment presenting a plurality of presentation media elements corresponding to the input media elements, wherein a time-based composition of the presentation media elements within the presentation segment is based at least on one or more of the input media elements.

### CROSS REFERENCE

This application claims the benefit of and priority from U.S. Provisional Patent application 61/218,083, entitled “Smart & Automatic Multimedia & Video Presentations Generator”, filed Jun. 18, 2009, the entire disclosure of which is incorporated herein by reference.

### FIELD

Some embodiments relate generally to the field of generation of media content and, more particularly, to generation of a multimedia presentation.

### BACKGROUND

Many users such as, for example, retailers, marketers, e-Retailers, e-Marketers, small and medium businesses, home users, web content platforms/providers, and the like may benefit greatly from producing video and/or multimedia content. For example, small businesses and/or individuals may use video and multimedia presentations to create and/or empower an online multimedia presence, e.g., in the fields of e-Commerce and e-Marketing, digital signage, and the like.

A multimedia presentation may demonstrate a product or a service, for example, in a vivid way, emphasizing a sale/marketing offering of the product or service, e.g., by demonstrating and/or emphasizing attributes of the product or service, gifts, coupons, and the like. The multimedia presentation may help a business owner to create a professional and serious façade to the business; may reduce customer uncertainty in web transactions by ‘giving a face’ to the business and/or by increasing engagement of potential customers and reducing the number of “abandoned shopping carts”.

Video and multimedia presentations can be used for an assortment of purposes such as displaying products for sale, real-estate properties for sale or for rent, cars for sale, video business card presenting a business and its services, presentations of “hot deals” and sale campaigns, product reviews and product comparisons, and the like.

Businesses may use different channels of their marketing mix to broadcast their marketing video presentations. A business may incorporate a presentation into a home website, publish the presentation as advertising in classified ads portals, business indexes such as the “yellow pages”, or any other related web site, publish the presentation to portable devices, such as cell phones, or even broadcast the presentation, e.g., over digital signage displays in market places and as TV ads.

Home users and non-professional users may also benefit from producing and broadcasting multimedia presentations such as Recipes' How-to presentations, dating web sites personal presentations, tourism tripping suggestions, video blogs, and the like.

Services of professional videographers may be relatively expensive.

‘Do it yourself’ video production using current available software editing and composition tools is very time consuming and requires creativity and skills for achieving an impressive and effective video.

Existing editing and multimedia presentation software tools are either too limited or too simplistic. For example, some software tools offer a one-fit-all movie template or a simplistic and almost random presentation of clips, usually based on pictures. Other software tools are complicated, for example, requiring editing and composition software packages.

Accordingly, the potential of video and multimedia presentations for e-Marketing, home movies and content generation is not fully realized

### SUMMARY

Some demonstrative embodiments include a device, system and/or method of generating a multimedia presentation based on input media elements, e.g., video, images, audio and/or text.

In some demonstrative embodiments, the presentation may be generated automatically and/or in a customized manner, such that a composition of the presentation, e.g., a time-based composition and/or a graphic-based composition of one or more segments of the presentation, is based on one or more of the input media elements, for example a context of the media elements and/or an association between the input media elements and one or more predefined presentation building blocks. In some demonstrative embodiments, a system may include a memory having stored thereon application instructions; and a processor to execute the application instructions resulting in a presentation-generation application able to receive a plurality of input media elements and to generate a multimedia presentation including at least one presentation segment presenting a plurality of presentation media elements corresponding to the input media elements, wherein a time-based composition of the presentation media elements within the presentation segment is based at least on one or more of the input media elements.

In some demonstrative embodiments, two or more of the presentation media elements are presented within the presentation segment at least partially simultaneously.

In some demonstrative embodiments, the plurality of presentation media elements include at least first and second presentation media elements, wherein one or more time-based presentation parameters for presenting the second presentation media element is based on one or more time-based presentation parameters for presenting the first presentation media element.

In some demonstrative embodiments, the presentation-generation application is able to determine the time-based composition of the presentation media elements by determining one or more time-based presentation parameters for presenting a presentation media element of the presentation media elements.

In some demonstrative embodiments, time-based parameters include at least one of a duration of the presentation media element, a beginning time of presenting the presentation media element and an end time of presenting the presentation media element.

In some demonstrative embodiments, the presentation media element includes at least a portion of at least one input media element of the input media elements, and wherein the presentation-generation application is able to adjust the portion of the input media element included within the presentation media element based on the time-based presentation parameters.

In some demonstrative embodiments, the presentation-generation application is able to exclude at least a portion of at least one of the input media elements from the presentation.

In some demonstrative embodiments, the presentation media elements include a plurality of media elements associated with a common predefined building block.

In some demonstrative embodiments, the plurality of presentation media elements includes a first media element, which includes at least one of a video and an image, and a second media element including a text element relating to a content of the first media element.

In some demonstrative embodiments, the presentation-generation application is able to associate the input media elements with a plurality of predefined presentation building-blocks based on input information corresponding to the input media elements, and wherein the presentation-generation application is able to determine presentation media elements to be included in the presentation segment based on the presentation building blocks.

In some demonstrative embodiments, the presentation-generation application is able to define the presentation segment based on a predefined composition, which defines one or more parameters of the time-based composition.

In some demonstrative embodiments, the presentation-generation application is able to select the composition from a plurality of predefined composition alternatives.

In some demonstrative embodiments, the presentation-generation application is able to determine the time-based composition based on at least one of a quality of at least one of the input media elements, a duration of at least one of the input media elements, a content of at least one of the input media elements, an association between two or more of the input media elements, a type of media included in one or more of the input media elements, and input information corresponding to the input media elements.

In some demonstrative embodiments, the presentation-generation application is able to receive from a user an indication of a presentation theme selected from a predefined set of presentation themes, and to define the time-based composition based on the selected theme.

In some demonstrative embodiments, the presentation-generation application is able to determine, based on one or more of the input media elements, at least one of a duration of the presentation segment, a graphical composition of the presentation segment, a number of the presentation media elements included in the presentation segment, and a relative placement of the presentation media elements included in the presentation segment.

In some demonstrative embodiments, the at least one presentation segment includes a sequence of a plurality of presentation segments including two or more presentation segments having different compositions.

In some demonstrative embodiments, the presentation-generation application is able to generate the presentation segment including one or more advertisements, which include advertisement content corresponding to a content of at least one of the presentation media elements.

In some demonstrative embodiments, the presentation media elements include at least one of a video element, an audio element, an image element, and a text element.

In some demonstrative embodiments, a computer-based method of customized video may include receiving, by a computing device, a plurality of input media elements; associating between the plurality of input media elements and a plurality of predefined presentation building-blocks; and generating, by the computing device, a multimedia presentation including a sequence of presentation segments, wherein a presentation segment of the sequence of presentation segments includes at least one presentation media element corresponding to at least one building block, and wherein the at least one presentation media element includes at least a portion of at least one input media element of the media elements associated with the at least one building block.

In some demonstrative embodiments, associating between the plurality of input media elements and the plurality of predefined presentation building blocks includes associating between the plurality of input media elements and the plurality of predefined building blocks based on input information corresponding to the input media elements.

In some demonstrative embodiments, generating the multimedia presentation includes automatically determining a composition of the presentation segment based on the input media elements associated with the building block.

In some demonstrative embodiments, determining the composition of the presentation segment includes determining a time-based composition of the at least one presentation media element.

In some demonstrative embodiments, determining the time-based composition includes determining the time-based composition based on at least one of a quality of at least one of the media elements associated with the building block, a duration of at least one of the media elements associated with the building block, a content of at least one of the media elements associated with the building block, a type of media included in at least one of the media elements associated with the building block, and input from a user.

In some demonstrative embodiments, the presentation building blocks are defined according to a presentation theme selected from a plurality of predefined presentation themes.

In some demonstrative embodiments, the sequence of presentation segments includes at least first and second presentation segments, which are based on a common predefined composition, and wherein the first presentation segment includes one or more presentation elements, which are not included in the second presentation element.

In some demonstrative embodiments, the method may include composing the presentation segment based on a presentation composition, which is selected from a plurality of predefined presentation composition alternatives.

In some demonstrative embodiments, the method may include determining, based on the at least one input media element associated with the building block, at least one of a duration of the presentation segment, a graphical composition of the presentation segment, a number of presentation media elements included in the presentation segment, and a relative placement of the presentation media elements to be included in the presentation segment.

In some demonstrative embodiments, the method mat include generating the presentation segment including one or more advertisements, which include advertisement content corresponding to a content of at least one of the presentation media elements.

In some demonstrative embodiments, the presentation media elements include at least one of a video element, an audio element, an image element, and a text element.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIGS. 2A, 2B, 2C, 2D, 2E and 2F schematically illustrate a sequence of respective presentation segments, in accordance with some demonstrative embodiments.

FIG. 3 schematically illustrates a building block information-set, in accordance with some demonstrative embodiments.

FIGS. 4A and 4B are screen-shot illustrations of first and second respective implementations of a user interface enabling a user to define and/or modify one or more building blocks, in accordance with some demonstrative embodiments.

FIG. 5A schematically illustrates a storyboard composition, in accordance with some demonstrative embodiments.

FIG. 5B illustrates a screen-shot of a presentation segment composed according to the composition of FIG. 5A, in accordance with some demonstrative embodiments.

FIGS. 6A and 6B schematically illustrate screen shots of two respective composition alternatives, respectively, in accordance with some demonstrative embodiments.

FIG. 7 is a screen-shot illustration of a presentation segment composed according to a storyboard template, in accordance with some demonstrative embodiments.

FIG. 8 schematically illustrates a method of generating a concrete storyboard, in accordance with some demonstrative embodiments.

FIG. 9 schematically illustrates a method of generating a multimedia presentation, in accordance with some demonstrative embodiments.

FIG. 10 schematically illustrates an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Some embodiments may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.16 standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), Wi-Fi, Wi-Max, ZigBee™, Global System for Mobile communication (GSM), 2G, 2.5G, 3G, 3.5G, or the like. Some embodiments may be used in various other devices, systems and/or networks.

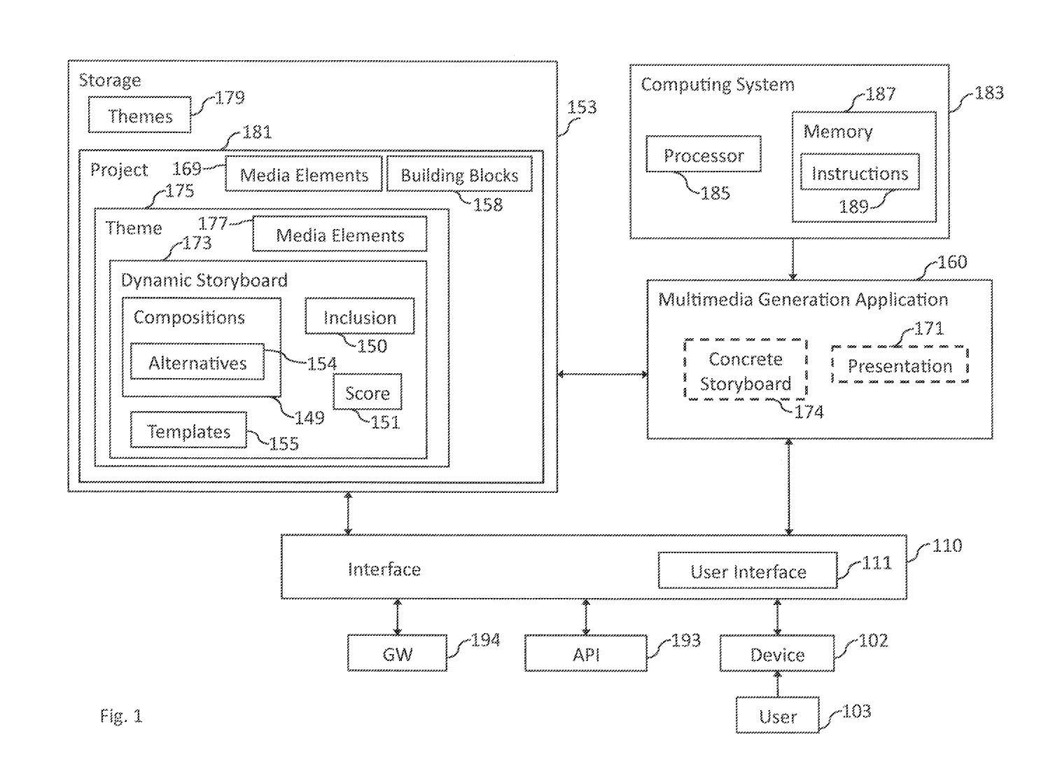

Reference is now made to FIG. 1, which schematically illustrates a block diagram of a system 100 in accordance with some demonstrative embodiments.

In some embodiments, system 100 includes one or more user stations or devices 102 allowing one or more users 103 to interact with at least one multimedia generation application 160, e.g., as described herein.

In some embodiments, devices 102 may be implemented using suitable hardware components and/or software components, for example, processors, controllers, memory units, storage units, input units, output units, communication units, operating systems, applications, or the like. For example, devices 102 may include, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a cellular telephone, a PCS device, a PDA device which incorporates a wireless communication device, a mobile or portable GPS device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a Smartphone, or the like.

In some embodiments, system 100 may also include an interface 110 to interface between users 103 and/or devices 102 and one or more elements of system 100, e.g., presentation generation application 160.

In some embodiments, presentation generation application 160 may be capable of communicating, directly or indirectly, e.g., via interface 110 and/or any other interface, with one or more suitable modules of system 100, for example, an archive, an E-mail service, an HTTP service, an FTP service, an application, and/or any suitable module capable of providing, e.g., automatically, input to presentation generation application 160 and/or receiving output generated by presentation generation application 160, e.g., as described herein.

In some embodiments, presentation generation application 160 may be implemented as part of any other suitable system or module, e.g., as part of any suitable server, or as a dedicated server.

In some embodiments, presentation generation application 160 may include a local or remote application executed by any suitable computing system 183. For example, computing system 183 may include a suitable memory 187 having stored thereon presentation generation application instructions 189; and a suitable processor 185 to execute instructions 189 resulting in presentation generation application 160. In some embodiments, computing system 183 may include a server to provide the functionality of presentation generation application 160 to users 103. In other embodiments, computing system 183 may be part of user station 102. For example, instructions 189 may be downloaded and/or received by users 103 from another computing system, such that presentation generation application 160 may be executed locally by user devices 102. For example, instructions 189 may be received and stored, e.g., temporarily, in a memory or any suitable short-term memory or buffer of user device 102, e.g., prior to being executed by a processor of user device 102. In other embodiments, computing system 183 may include any other suitable computing arrangement and/or scheme.

In some embodiments, interface 110 may be implemented as part of presentation generation application 160, as part of user devices 102 and/or as part of any other suitable system or module, e.g., as part of any suitable server. In one example, interface 110 may be implemented, for example, as middleware, as part of any suitable application, and/or as part of a server. Interface 110 may be implemented using any suitable hardware components and/or software components, for example, processors, controllers, memory units, storage units, input units, output units, communication units, operating systems, applications. In some embodiments, interface 110 may include, or may be part of a Web-based application, a web-site, a web-page, a stand-alone application, a plug-in, an ActiveX control, a rich content component (e.g., a Flash or Shockwave component), or the like.

In some embodiments, interface 110 may interface presentation generation application 160 with one or more other modules and/or devices, for example, a gateway 194 and/or an application programming interface (API) 193, for example, to transfer information from presentation generation application 160 to one or more other, e.g., internal or external, parties, users, applications and/or systems using any suitable communication method, e.g., E-mail, Fax, SMS, Twitter, a website, an the like.

In some demonstrative embodiments, presentation generation application 160 may automatically generate a multimedia presentation 171 based on a plurality of input media elements (“media clips”) 169, e.g., as described in detail below.

The phrase “media element” as used herein may refer to any suitable file, clip and/or record including any suitable type of media, e.g., text, video, audio, image, graphical shape and path, animation segment, 3D texture, 3D structure and quad and/or any combination of one or more media elements to be rendered, presented or played for a certain period of time.

In some demonstrative embodiments, multimedia presentation 171 may include any suitable file, record and/or clip of any suitable multimedia, video and/or animation format, for example, AVI, Windows Media Format (WMV), MPEG-1, MPEG-2, MPEG-4, e.g., H.263, H.264 encoding, Adobe Flash Video (FLV), QuickTime, RealVideo, DivX, Theora, VC-1, Cinepak, Huffyuv, Lagarith, SheerVideo, Adobe Flash animation (SWF), Microsoft Power Point (ppt, pptx), and the like.

In some demonstrative embodiments, presentation generation application 160 may receive media elements 169 as input from user 103.

In one embodiment, one or more of media elements 169 may be uploaded by user 103, e.g., using interface 110. For example, user interface 110 may include a suitable user interface 111, e.g., a suitable graphical-user-interface (GUI), capable of receiving media elements 169 from user 103 and/or from any other suitable source.

In one example, media elements 169 may include videos, pictures and/or audio tracks provided by user 103. For example, user 103 may provide media elements 169 including videos, pictures and/or audio tracks recorded or captured especially for the presentation 171 and/or for any other purpose.

For example, user 103 may import media elements 169 from a capturing device, e.g., a camera, upload media elements 169 from a local computer or storage device, a network storage device, an online file storage device, and the like. Media elements 169 may be stored in association with and/or as part of a suitable presentation project repository 181 to be used for generating presentation 171.

Some embodiments are described herein with reference an application, e.g., application 160, interacting with a user 103, e.g., user 103, for example, such that application 160 may receive information, media elements and/or any other suitable input from user 103, e.g., as described below. However, in other embodiments application 160 may be capable of interacting with one or more other sources, in addition to or instead of the interaction with user 103. For example, application 160 may receive information, media elements and/or any other suitable input, e.g., as described herein, from any suitable application, interface and/or any other entity and/or element of system 100.

Some embodiments are described herein with reference to an application, e.g., application 160, interacting via an interface, e.g., interface 110, to receive input. However, in other embodiments, application 160 may be capable of interacting with one or more sources to directly, e.g., without any interface. For example, application 160 may interact directly with a device, e.g., device 102, which may include, for example, a video camera, a camera, a cellular device, a Smartphone, an audio capturing device, a suitable media storage and/or capturing device, and the like, to receive input, e.g., media elements, directly from device 102, e.g., without using interface 110 and/or without interaction with user 103.

In some demonstrative embodiments, presentation project repository 181 may be implemented as part of any suitable storage and/or memory 153, for example, as part of a remote storage and/or server, e.g., as part of computing system 183 or a server associated with computing system 183. For example, project 181 may be maintained as part of a video generation service and/or gateway (“the video generation server”), which may include application 160 and/or store project 181, media elements 169 and/or presentation 171. In other embodiments, application 160 and/or store project 181, media elements 169 and/or presentation 171 may be maintained locally, e.g., as part of user device 102.

In one example, user 103 may want to generate multimedia presentation 171 displaying a DVD player product for sale. Accordingly, user 103 may record media files 169 including pictures and/or video footage of the DVD player package and usage, e.g., using a DV camcorder, a camera a mobile phone, a video camera, and the like. User 103 may import the media files into project repository 181, e.g., directly from the capturing devices and/or from a local and/or online storage.

In other embodiments, one or more of media elements 169 may be received from and/or generated by any other suitable source. For example, user 103, device 102 and/or any other suitable module, device or application, may provide media elements 169 in any suitable manner and/or from any suitable source, e.g., from a provider or manufacturer of the DVD player, from a website, and the like.

In some demonstrative embodiments, multimedia elements 169 may received and/or imported from any suitable source and/or storage, for example, any suitable multimedia capturing device, e.g., a DV camcorder, a picture cameras, a mobile devices, video and picture web-cameras, and the like.

In some demonstrative embodiments, interface 110 may allow user 103 to import media elements from a suitable capturing device, for example, using a suitable ‘file open’ dialog box like display, e.g., if the capturing device offers a file-system-like interface. Additionally or alternatively, interface 110 may allow user 103 to locate media elements 169 on the capturing devices, by pointing and suggesting folders and media files on the capturing device that may include media elements 169. For example, interface 110 and/or application 160 may prompt user 103 to connect the capturing device to his computer. User interface 111 may identify the file system drive name, e.g., using the device driver software interface or by detecting the new operating system mapped drive name generated after the user connected his device to his computer. Interface 110 may then scan the storage file system for known media files and present the supported media files and their folders to user 103, e.g., sorted by date in descending order.

In some demonstrative embodiments, interface 110 and/or application 160 may support importing video files from one or more of the following common and widespread formats and encoding types: AVI, Windows Media Format (WMV), MPEG-1, MPEG-2, MPEG-4 (including H.263, H.264 encoding), Adobe Flash Video (FLV), QuickTime, RealVideo, DivX, Theora, VC-1, Cinepak, Huffyuv, Lagarith, SheerVideo, and the like; importing picture files from one or more of the following common and widespread formats and encoding types: GIF, JPEG, Bitmap, PNG, TIFF, Exif, RAW, PPM, CGM, SVG, and the like; and/or importing audio tracks from one or more of the following common and widespread formats and encoding types: WAV, OGG, MPC, Flac, Aiff, Raw, Au, Mid, GSM, Vox, AAC, MP3, MMF, WMA, Real Audio (ra), M4P, DVF, and the like.

In some demonstrative embodiments, for example, for DV camcorders, web-cameras, microphones and other digital video and audio capturing devices that require capturing media straight from the device or from their storage or cassettes, interface 111 and/or application 160 may offer a capturing user interface including features for selecting the video and audio devices for capturing, start capturing, stop capturing and pause capturing, rewinding the device storage or cassette, previewing the capture media and more. The output of the media capturing process may include video media files, including video tracks and\or audio tracks, which may be imported into project 181 as one or more media elements 169.

In some demonstrative embodiments, interface 110 and/or application 160 may support importing media elements 169 from one or more suitable storage and/or capturing locations such as, for example, device 102, storage 153, the user's desktop computer's hard-disks, portable storage devices, a service file storage server, file sharing websites and portals, other users' computers, and the like.

In some demonstrative embodiments, the process of importing media elements 169 may vary by imported files format, encoding type and/or by imported media storage location. Interface 110 may opt to leave imported files in their original format and encoding type or convert the media files into one or more of the platform-preferred formats. Interface 110 may be configured to convert/not convert all type of formats or only a predefined set of formats. In case interface 110 opts to convert the media files, the conversion may be processed locally on storage 153 or sent to another online or network server.

In some demonstrative embodiments, media elements 169 may be stored as part of the video generation server, project repository 181, on storage 153, a suitable network or online storage server, user device 102, and/or any other suitable storage or location.

In some demonstrative embodiments, application 160 and/or interface 110 may be downloaded to and/or installed on a suitable capturing and/or storage device, e.g., device 102, for example, a video camera, a camera, a cellular device, a Smartphone, an audio capturing device, and the like. According to these embodiments, application 160 and/or interface 110 may be capable of interacting with device 102 and/or user 103 to cause device 102 to capture one or more media elements and/or to associate the captured media elements with one or more predefined presentation building blocks and/or scenes, e.g., as are described below. For example, application 160 and/or interface 110 may be installed on a Smartphone, and may be capable of interacting with a user of the Smartphone to request from the user to point a camera of the Smartphone in a direction of a room to be presented as part of a real-estate offering presentation. Application 160 may receive from the camera images and/or video captured by the camera, and application 160 may automatically associate the captured images and/or video with a “room” building block, e.g., as described below.

In some demonstrative embodiments, interface 110 may offer and\or integrate and\or interface with services known as ‘stock footage’ services, providing pre-captured and usually professional captured videos or pictures or audio or music media clips sorted and tags for different purposes. For example, a video ‘stock footage’ repository may include video clips presenting beautiful and professional captured real-estate properties that can be rendered into a presentation of a ‘Real-Estate Property for Sale’. These services may be offered online or installed on the user's computer or network.

In some demonstrative embodiments, interface 110 and/or application 160 may provide user 103 with the ability to edit, modify and/or amend media elements 169. For example, interface 110 and/or application 160 may allow user 103 to generate media elements, e.g., by allowing the user to select a segment within a media element or split a media element into several media elements and defining them as separate media elements. This operation may be required, for example, in cases where a media element includes several sub media elements recorded together. For example, user 103 may record a video of several rooms within a real-estate property traveling from room to room without stop recording. In order for user 103 to be able to attach the right media element to each room building block, e.g., as described below, user 103 may generate a separate media element per each room out of the original media clip. Additionally or alternatively, interface 110 and/or application 160 may allow user 103 to delete segments within a media element. User 103 may want to remove segments within a media element, ensuring that these segments will not be incorporated into presentation 171. This operation may be required, for example, in cases where the media element includes media of very low quality. Additionally or alternatively, interface 110 and/or application 160 may allow user 103 to “highlight” and/or “mark” segments within a media element. For example, user 103 may highlight an important segment, increasing the possibility of application 160 incorporating the important segment into presentation 171. Additionally or alternatively, interface 110 and/or application 160 may allow user 103 to define one or more segments of a media element as “must incorporate segments”. For example, user 103 may want to force application 160 to include a specific media segment. This option is especially helpful if, for example, presentation 171 does not include the segment. Additionally or alternatively, interface 110 and/or application 160 may allow user 103 to merge segments. User 103 may want to merge two segments or more into one continuous media element, instructing application 160 prefer incorporating the continuous merged media element over the incorporation of some of the media elements in an arbitrary order.

In some demonstrative embodiments, application 160 and/or interface 110 may allow user 103 to “tag” a media element 169. The “tagging” of a media element as described herein may include associating the media element with one or more presentation building blocks, e.g., as described below, and/or attaching to the media element any other suitable information, e.g., text, for example, user 103 may tag a media element 169 by attaching to the media element any suitable text.

In some demonstrative embodiments, interface 110 and/or application 160 may analyze a media element 169, for example, for quality and/or importance, e.g., as described below. Interface 110 and/or application 160 may provide, for example, one or more visual suggestions regarding one or more segments of the analyzed media element, e.g., suggesting to remove one or more segments having low quality or no importance and/or suggesting to highlight one or more segments having high quality and/or high importance.

In some demonstrative embodiments, presentation generation application 160 may allow user 103 to create multimedia presentation 171 having, for example, a professional look & feel, e.g., almost automatically and/or with no required creativity and/or prior production skills, as described below.

In some demonstrative embodiments, presentation generation application 160 may generate, e.g., automatically, presentation 171 including a sequence of presentation elements (also referred to as “presentation segments” or “scenes”) which may be composed by application 160, for example, by applying media elements 169 to one or more predefined compositions, for example, according to one or more predefined rules, e.g., as described in detail below.

The phrase “presentation segment” as used herein may refer to any suitable part, or portion of a multimedia presentation, e.g., a “screen”, a “scene”, a “video scene”, a sequence of video frames, and the like.

In some demonstrative embodiments, presentation generation application 160 may associate, e.g., automatically, and/or based on input from user 103, between two or more media elements 169 to be presented, e.g., at least partially simultaneously, within a common presentation segment of presentation 171 based on any suitable criteria, e.g., as described herein.

In one example, presentation generation application 160 may associate between a first media element 169, which may include a video of a product, e.g., a video presenting features of the DVD player; a second media element 169, which may include text relating to the product, for example, text relating to a content of the video, e.g., text describing the features of the DVD player; a third media element 169, which may include audio relating to the product, for example, audio relating to the content of the video, e.g., an audio track including a description of the features of the DVD player, or background music to be played when presenting the text and/or video elements; and so on.

In some demonstrative embodiments, presentation generation application 160 may automatically determine a composition of the associated media elements within the common presentation segment based on one or more attributes of the associated media elements, for example, such that different associated media elements may result in a different composition of the associated media elements within the common presentation segment, e.g., as described below.

The term “composition” as used herein with respect to a presentation segment may refer to a graphical-based and/or time-based arrangement, layout and/or structuring of the presentation segment. For example, the composition of the presentation segment may be defined by defining one or more time-based attributes and/or graphic-based attributes of one or more media elements and/or other elements to be presented within the presentation segment. The time-based attributes of a media element to be presented may include a beginning time to begin presenting the media element, a duration of presenting the media element, an end time to end the presentation of the media element, and the like. The graphic-based attributes of a media element to be presented may include a size at which the media element is to be presented, a location at which the media element is to be presented, a color at which the media element is to be presented, an orientation at which the media element is to be presented, and the like. The time-based and/or graphic-based attributes may be defined in an absolute or fixed manner, or in a relative manner, e.g., relative to the corresponding attributes of one or more other media elements. Presentation generation application 160 may determine the composition of the presentation segment based on a storyboard composition and/or a composition alternative, as are described below.

In one example, presentation generation application 160 may determine a composition of the first, second and third associated media elements, as are described above, within a common presentation segment, e.g., automatically.

For example, presentation generation application 160 may determine, e.g., automatically, a timing of presenting the first, second and third media elements within the presentation segment, e.g., by determining a beginning time, end time and/or duration of presenting the first, second and third media elements within the presentation segment. For example, presentation generation application 160 may determine that the presentation of the video presenting features of the DVD player is to begin at a first time, e.g., a certain time period after a beginning of the presentation segment; that the presentation of the audio relating to the content of the video is to begin at a second time, for example, relative to the first time, e.g., one second after the first time; that the presentation of the text relating to the features of the DVD player is to begin at a third time, for example, relative to the first time, e.g., two seconds after the first time; and/or that the presentation of the text relating to the features of the DVD player is to last for a certain time period, for example, relative to a duration of the presentation of the video and/or audio, e.g., such that the presentation of the text will end two seconds prior to the presentation of the video.

Additionally or alternatively, presentation generation application 160 may determine, e.g., automatically, a graphical composition of the first, second and third media elements within the presentation segment, e.g., by determining a location, size, and/or any other suitable graphical and/or display attributes relating to the media elements. For example, presentation generation application 160 may determine that video and text relating to the features of the DVD player are to be presented according to a first composition including presenting the text over the video, a second composition including presenting the text aside the video, and/or any other composition

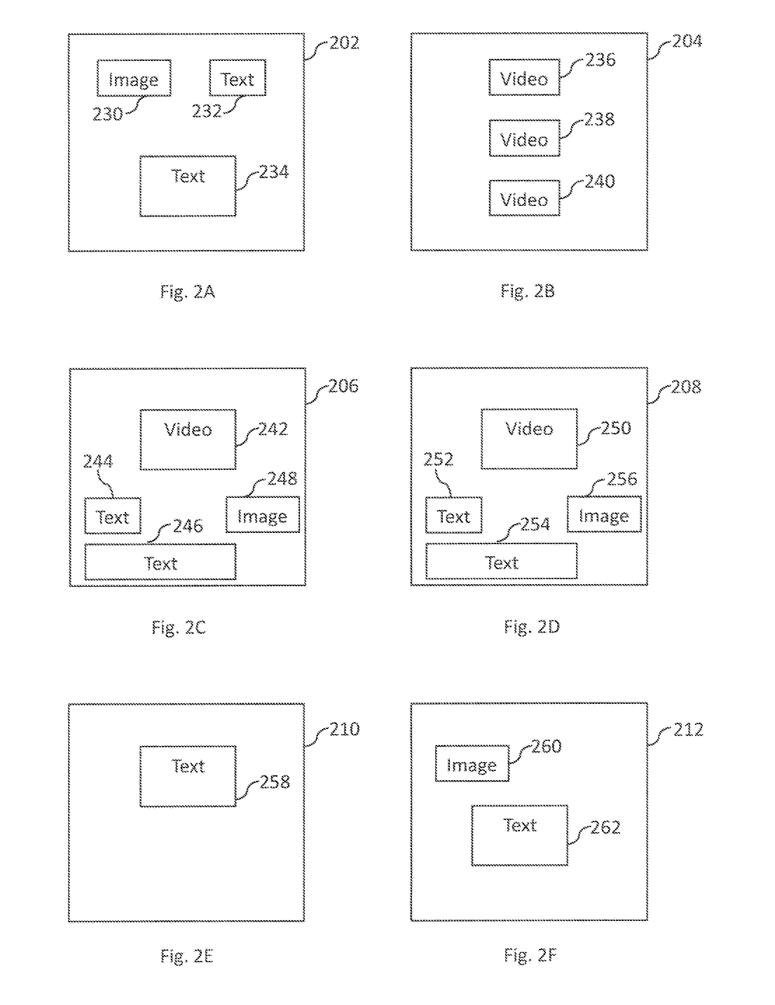

Reference is made to FIGS. 2A, 2B, 2C, 2D, 2E and 2F, which schematically illustrate a sequence of respective presentation segments 202, 204, 206, 208, 210 and 212, in accordance with some demonstrative embodiments. In some embodiments, presentation segments 202, 204, 206, 208, 210 and/or 212 may be part of a presentation, e.g., presentation 171 (FIG. 1), e.g., a presentation relating to an offering of real estate property, or to any other suitable presentation.

In some demonstrative embodiments, presentation segment 202 may include a first “opening” scene of the presentation. Presentation segment 202 may include an initial presentation of the offer. For example, presentation segment 202 may include a composition of a text presentation element 232, e.g., including a name of an entity offering the real estate property, a text presentation element 234, e.g., including a name of the real estate property, and/or an image presentation element 230, e.g., including an image, symbol or icon of the entity offering the real estate property.

In some demonstrative embodiments, application 160 (FIG. 1) may receive a plurality of input media elements 169 (FIG. 1) and generate multimedia presentation 171 (FIG. 1) including at least one presentation segment, e.g., segments 202, 204, 206, 208 and/or 210, presenting a plurality of presentation media elements corresponding to input media elements 169 (FIG. 1), e.g., as described below.

In some demonstrative embodiments, presentation segment 204 may include a second “opening” scene of the presentation. Presentation segment 204 may include a “summary” of video clips relating to the real estate property. For example, presentation segment 204 may include a composition of a video presentation element 236, for example, including a first video of a first room, e.g., a kitchen, in the real estate property, a video presentation element 238, e.g., including a second video of the first room in the real estate property, and a presentation video element 240, e.g., including a video of a second room, e.g., a bedroom, in the real estate property.

In some demonstrative embodiments, presentation segment 206 may include a first “feature” scene of the presentation. Presentation segment 206 may include a presentation of the first room of the property, e.g., the kitchen. For example, presentation segment 206 may include a composition of a video element 242, for example, including a combination of the first and second videos of the first room and/or portions thereof, a text presentation element 244, e.g., including a name of the first room, a text presentation element 246, e.g., including a description of features relating to the first room, and an image presentation element 248, for example, including a symbol or icon corresponding to the first room, e.g., an icon of a stove.

In some demonstrative embodiments, presentation segment 208 may include a second “feature” scene of the presentation. Presentation segment 208 may include a presentation of the second room of the property, e.g., the bedroom. For example, presentation segment 208 may include a composition of a video element 250, for example, including the video of the second room and/or portions thereof, a text presentation element 252, e.g., including a name of the second room, a text presentation element 254, e.g., including a description of features relating to the second room, and an image presentation element 256, for example, including a symbol or icon corresponding to the second room, e.g., an icon of a bed.

In some demonstrative embodiments, presentation segment 210 may include an “offering” scene of the presentation. Presentation segment 210 may include a summary of the offer. For example, presentation segment 210 may include a composition of a text presentation element 262, e.g., including a price of the property, a number of rooms, an age of the property and/or any other information relating to the property.

In some demonstrative embodiments, presentation segment 212 may include a “closing” scene of the presentation. Presentation segment 212 may include contact details of the entity offering the property. For example, presentation segment 212 may include a composition of a text element 262, e.g., including a name of the entity, a telephone number, an address, and/or any other information relating to the entity offering the property, and an image presentation element 260, e.g., including a picture of a real-estate agent offering the property.

In some demonstrative embodiments, a composition of presentation segments 202, 204, 206, 208 and/or 210 may be determined, e.g., by application 160 (FIG. 1), based, for example, on the media elements to be presented in presentation segments 202, 204, 206, 208 and/or 210 and/or one or more predefined rules and/or functions, for example, one or more rules and/or functions of a dynamic storyboard, e.g., one or more predefined composition alternatives, inclusion functions and/or score functions, as are described in detail below. For example, presentation generation application 160 (FIG. 1) may determine a timing of presenting elements 230, 232 and/or 234, e.g., such that element 230 is presented first and elements 232 and 234 are presented during time periods relative to a time period of displaying element 230; and/or a graphical composition of presenting elements 230, 232 and/or 234, e.g., such that elements 230, 232 and/or 234 are presented at a certain arrangement, size and/or location. Presentation generation application 160 (FIG. 1) may determine a timing of presenting elements 236, 238 and/or 240, for example, such that elements 236, 238 and/or 240 are presented during a common time period time, e.g., by clipping and/or stretching one or more of video elements 236, 238 and 240 to fit the time period; and/or a graphical composition of presenting elements 236, 238 and/or 240, e.g., such that elements 236, 238 and/or 240 are presented at a certain arrangement, size and/or location. Presentation generation application 160 (FIG. 1) may determine a timing of presenting elements 242, 244, 246 and/or 284, e.g., such that element 242 is presented first and elements 244, 246 and/or 248 are presented during time periods relative to a time period of displaying element 242; and/or a graphical composition of presenting elements 242, 244, 246 and/or 284, e.g., such that elements 242, 244, 246 and/or 284 are presented at a certain arrangement, size and/or location. Presentation generation application 160 (FIG. 1) may determine a timing of presenting elements 250, 252, 254 and/or 256, e.g., such that element 250 is presented first and elements 252, 254 and/or 256 are presented during time periods relative to a time period of displaying element 250; and/or a graphical composition of presenting elements 250, 252, 254 and/or 256, e.g., such that elements 250, 252, 254 and/or 256 are presented at a certain arrangement, size and/or location. Presentation generation application 160 (FIG. 1) may determine a graphical composition of presenting element 258, e.g., such that element 258 is presented at a certain arrangement, size and/or location. Presentation generation application 160 (FIG. 1) may determine a timing of presenting elements 260 and/or 262, e.g., such that element 262 is presented first and element 260 is presented during a time period relative to a time period of displaying element 262; and/or a graphical composition of presenting elements 260 and/or 262, e.g., such that elements 260 and/or 262 are presented at a certain arrangement, size and/or location.

In some demonstrative embodiments, a time-based composition of the presentation media elements within presentation segments 202, 204, 206, 208 and/or 210 may be based at least on one or more of the input media elements 169 (FIG. 1), e.g., as described below.

In some demonstrative embodiments, two or more of the presentation media elements within a presentation segment of presentation segments 202, 204, 206, 208 and/or 210 may be presented within the presentation segment at least partially simultaneously. For example, presentation elements 242, 244, 246 and/or 248 may be presented at least partially simultaneously within presentation segment 206.

In some demonstrative embodiments, one or more time-based presentation parameters for presenting a first presentation media element within a presentation segment, e.g., presentation element 242, may be based on one or more time-based presentation parameters for presenting a second presentation media element within the presentation segment, e.g., presentation element 244. For example, a beginning, duration and/or end of presenting presentation element 242 may be based on a beginning, duration and/or end of presenting presentation element 244, e.g., as described below.

In some demonstrative embodiments, at least one presentation media element of elements 230, 232, 234, 236, 238, 238, 240, 242, 244, 246, 248, 250, 252, 254, 256, 258, 260 and 262 may include at least a portion of at least one input media element of input media elements 169 (FIG. 1), and application 160 (FIG. 1) may select and/or adjust the portion of the input media element included within the presentation media element, e.g., as described below. In one example, application 160 (FIG. 1) may exclude at least a portion of at least one of the input media elements 169 (FIG. 1) from presentation 171 (FIG. 1), e.g., such that none of segments 202, 204, 206, 208 and 210 include at least a portion of at least one of the input media elements 169 (FIG. 1).

In some demonstrative embodiments, two or more of elements 230, 232, 234, 236, 238, 238, 240, 242, 244, 246, 248, 250, 252, 254, 256, 258, 260 and 262 may be associated with a common predefined building block. For example, elements 242, 244 and 246 may be associated with a room building block, e.g., as described below.

In some demonstrative embodiments, application 160 (FIG. 1) may define presentation segments 202, 204, 206, 208 and/or 210 based on a predefined composition, e.g., as described below.

In some demonstrative embodiments, application 160 (FIG. 1) may determine, based on one or more of the input media elements 169 (FIG. 1), at least one of a duration of presentation segments 202, 204, 206, 208 and/or 210, a graphical composition of presentation segments 202, 204, 206, 208 and/or 210, a number of the presentation media elements included in presentation segments 202, 204, 206, 208 and/or 210, and a relative placement of the presentation media elements included in presentation segments 202, 204, 206, 208 and/or 210, e.g., as described below.

Referring back to FIG. 1, in some demonstrative embodiments, presentation generation application 160 may generate presentation 171 by applying media elements 169 to a predefined storyboard template (“the dynamic storyboard”) 173, e.g., automatically and/or based on input from user 103, to generate a concrete storyboard 174, for example, based on one or more predefined storyboard compositions, rules and/or functions, e.g., as described in detail below.

In some demonstrative embodiments, dynamic storyboard 173 and/or concrete storyboard 174 may be analogous to a storyboard used in the video and/or film industries to define a timed sequential of images, displaying the graphic layouts of movie scenes. For example, dynamic storyboard 173 may define a framework, e.g., including one or more predefined presentation compositions (also referred to as “scene compositions”) and/or one or more predefined rules, as described below, for generating concrete storyboard 174, which in turn may define specific rendering instructions for generating presentation 171 based on media elements 169 and/or specific input from user 103, e.g., as described below.

In some demonstrative embodiments, dynamic storyboard 173 may be part of and/or associated with a predefined presentation theme 175, which may define a specific type of presentation, e.g., a having a specific graphical and/or audio look and feel.

In some demonstrative embodiments, presentation theme 175 may include dynamic storyboard 173 and, optionally, one or more theme-related media elements 177 related to presentation theme 175. For example, media elements 177 may include a video and/or image to be presented as a background of presentation 171 in accordance with presentation theme 175, audio to be played as a background of presentation 171 in accordance with presentation theme 175, and the like.

In some demonstrative embodiments, presentation theme 175 may include a presentation theme selected, e.g., by user 103 and/or application 160, from a plurality of predefined presentation themes 179. For example, presentation themes 179 may include different themes corresponding to an offering of a product, an offering of a service, and the like. In one example, presentation themes 179 may include a plurality of different presentation themes relating to an offer of real estate. For example, a first presentation 179 theme may relate to a first type of real estate offer, e.g., a quiet countryside house; a second presentation 179 theme may relate to a second type of real estate offer, e.g., a “young” apartment in a central location; a third presentation 179 theme may relate to a third type of real estate offer, e.g., a building to be purchased as an investment, and the like.

In some demonstrative embodiments, presentation theme 175 may group together dynamic storyboard 173 and media elements 177 according to a desired look and/or feel. For example, a presentation theme 175 called ‘a quiet stroll in the village’ may include dynamic storyboard 173 and media elements 177 for generating presentation 171 in the form of a calm and/or soft video or multimedia presentation suitable for presenting real-estate properties for sale on the countryside. According to this example, dynamic storyboard 173 may include the specifications and algorithms required for generating concrete storyboard 174 by combining media elements 169, e.g., property's videos, pictures and/or audio tracks, which may be supplied by user 103, e.g., a real-estate agent, with textual information describing the property and its rooms, with media elements 177, e.g., a video, audio and/or picture background, graphical panels, and the like.

Different themes 179 may define different dynamic storyboards 173, e.g., having a different definition of one or more presentation compositions, different algorithmic logic, defining a different length of presentation 171, defining different compositions, functions and/or rules, e.g., different inclusion and/or score functions, e.g., as described below, making different use of long or short segments of video, making different use of pictures only or a combination of pictures and videos, defining tempo of presentation 170, defining different colors, graphical elements, effects and transitions, having different levels of text and/or information usage, defining a different quality of graphics (from simple 2D graphics to complicated 3D scenes), defining voice over inclusion or just background music, defining different inclusion of branded elements (such as icon of the user business, picture of the business owner) or more simple and general theme, and the like.

In some demonstrative embodiments, application 160 and/or interface 110 may allow user 103 to select theme 175, e.g., after importing media elements 169 and/or specifying a plurality of building blocks 185, as described below. According to these embodiments, application 160 may automatically filter themes 179, e.g., based media elements 169 and/or one or more building blocks 158, as are described below, offering user 103 to select theme 175 out of the most appropriate and suitable groups of themes. For example, in case project 181 includes a large number of very short video clips, application 160 may offer user 103 a group of presentation themes 179 marked as high tempo themes.

In some demonstrative embodiments, presentation theme 175 may include a predefined set of background music tracks, including the instructions on how and when to incorporate them into presentation 171. Presentation theme 175 may include a list of allowed background music tracks for user 103 to select from. Additionally or alternatively, application 160 may provide user 103 with a general list of background music tracks for selection and/or user 103 may also opt to import and use any suitable personal background music track.

In some demonstrative embodiments, application 160 and/or interface 110 may allow user 103 to adjust, configure, customize and/or update theme 175, for example, by allowing user 103 to adjust an/or define a color palette to be used by theme 175, a logo to be implemented as part of the theme, one or more timing parameters to be used by theme 175, e.g., as are described below, a background to be used by theme 175, one or more graphical attributes of theme 175, e.g., parameters of frames used by theme 175, one or more effects to be used by theme 175, one or more graphical elements to be used by theme 175, and the like.

In some demonstrative embodiments, interface 110 may allow user 103 to communicate with presentation generation application 160, for example, to create a new presentation generation project 181 for generating presentation 171, to select a presentation theme 175, to import media elements 169 and/or specify “ingredients” of a “story” to be told by presentation 171, e.g., as described below.

In some demonstrative embodiments, presentation generator 160 may generate presentation 171, e.g., automatically, based on a plurality of presentation building blocks 158, which may be defined in accordance with dynamic storyboard 173 and/or associated with media elements 169. For example, application 160 may generate one or more presentation segments of presentation 171 by determining a time-based and/or graphic-based composition of one or more building blocks 158, e.g., as described in detail below.

The phrase “building block” as used herein with relation to a presentation, e.g., presentation 171, may include any suitable form of information element relating to at least one media element 169 and/or at least one portion of the presentation, e.g., a presentation segment or scene. The building block may include a set of one or more data fields, which may be related with one or more media elements 169, e.g., as described below. For example, a building block 158 may include or relate to a predefined feature, e.g., a “price” building block may relate to a price of an asset and, accordingly, the “price” building block may be associated with at least one media element relating to the price of the asset. The “price” building block may be presented in one or more presentation segments, for example, as part of an opening scene, an offering scene and/or a closing scene, e.g., as described above with reference to FIGS. 2A-2F.

In some demonstrative embodiments, dynamic storyboard 173 may include a predefined building block information-set including a set of predefined allowed building blocks to be included as part of presentation 171, and a definition of types of information to be included in each type of building block, e.g., as described below.

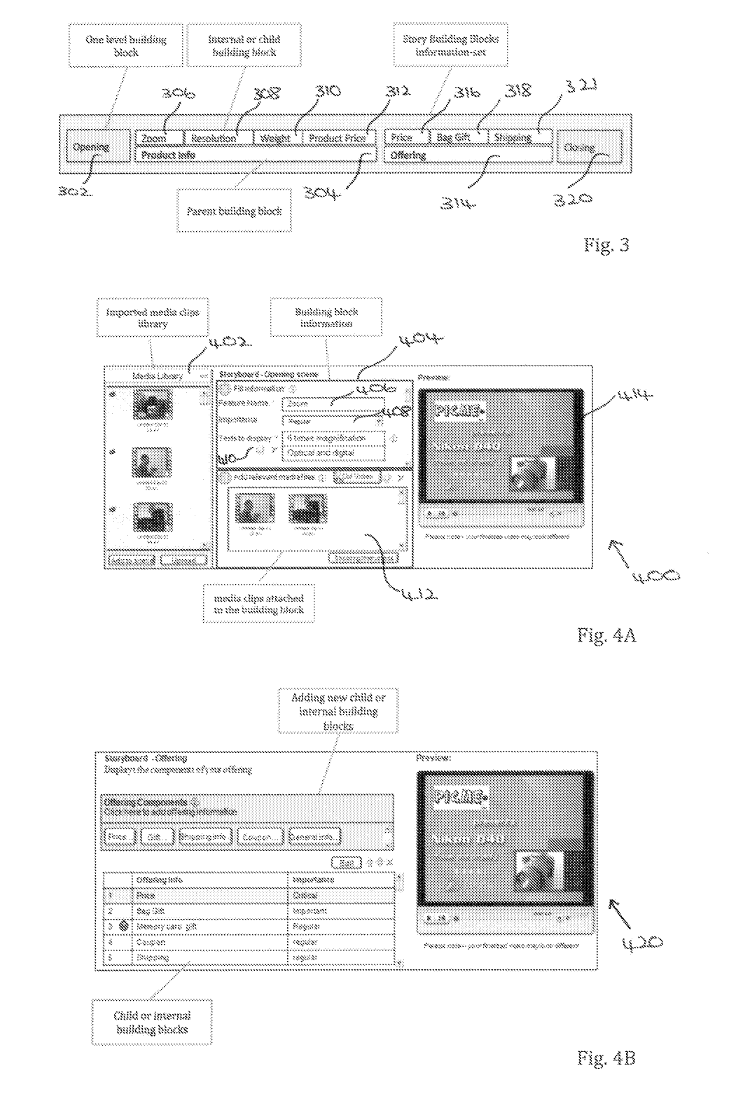

FIG. 3 schematically illustrates a building block information-set 300, in accordance with some demonstrative embodiments. Building block information-set 300 may include a group of building blocks associated with dynamic storyboard 173 (FIG. 1). In one embodiment, building block information-set 300 may refer to presentation 171 (FIG. 1) including an offering for sale of a camera.

As shown in FIG. 3, building block information-set 300 may include one or more one-level building blocks, e.g., an opening building block 302 defining information, e.g., text, video image and/or audio, to included as part of an opening segment of presentation 171 (FIG. 1), and/or a closing building block 320 defining information to included as part of a closing segment of presentation 171 (FIG. 1); one or more hierarchical building blocks including a parent building block and one or more internal or nested, e.g., “child” and/or “grandchild”, building blocks, for example, a product information building block 304 including a plurality of child building blocks, e.g., a zoom building block 306, a resolution building block 308, a weight building block 310, and/or a product price building block 312, and/or an offering building block 314 including a plurality of child building blocks, e.g., a price building block 316, a gift building block 318 and/or a shipping information building block 321.

In some demonstrative embodiments, application 160 (FIG. 1) may define building blocks 158 (FIG. 1), specify information to be included in building blocks 158 (FIG. 1) and/or associate between media elements 169 (FIG. 1) and building blocks 158 (FIG. 1), for example, automatically and/or based on input, e.g., input received from user 103 (FIG. 1), e.g., via interface 111 (FIG. 1) and/or from any other source.

In some demonstrative embodiments, dynamic storyboard 173 (FIG. 1) may define a structure of building block information-set 300 based, for example, on the type and/or context of storyboard 173 (FIG. 1). For example, according to the embodiment of FIG. 3, dynamic storyboard 173 (FIG. 1) may define building block information-set 300 to include opening building block 302, product information building block 304, offering building block 314 and closing building block 320. Application 160 (FIG. 1) may enable user 103 (FIG. 1) to define and/or modify building blocks 306, 308, 310, 312, 316, 318 and/or 320, for example, using interface 111 (FIG. 1), e.g., based on user preference and/or the content of media elements 169 (FIG. 1).

FIG. 4A is a screen-shot illustration of an implementation of a user interface 400, e.g., user interface 111 (FIG. 1), enabling a user, e.g., user 103 (FIG. 1), to define and/or modify one or more building blocks, in accordance with some demonstrative embodiments. As shown in FIG. 4A, user interface 400 may include an information portion 404 allowing the user to view and/or define information relating to the building block. For example, portion 404 may include a name field 406 to allow the user to define a name of the building block, e.g., “zoom”; an importance filed 408 to allow the user to define a degree of importance for the building block, e.g., regular, important and the like; and/or at least one text field 410 to allow the user to provide text to be presented as part of the building block. User interface 400 may include a library portion 402 to provide the user with a list of optional media elements to be associated with the building block. User interface 400 may include media-element portion 412 to allow the user to associate the building block with one or more media elements of library 402. User interface may include a preview pane to present a preview of the building block based on the portions 404 and 412 specified by the user.

FIG. 4B is a screen-shot illustration of an implementation of a user interface 420, e.g., user interface 111 (FIG. 1), enabling a user, e.g., user 103 (FIG. 1), to define and/or modify one or more building blocks, in accordance with some demonstrative embodiments. As shown in Fig, 4B, interface 420 may include a multi-level interface enabling the user to view and/or define information relating to a plurality of building. As shown in FIG. 4B, interface 420 may allow the user to view and/or define a two-level building block called ‘Offering’ for a specific camera for sale presentation, describing the unique offering.

Referring back to FIG. 1, in some demonstrative embodiments, presentation generation application 160 and/or interface 110 may allow user 103 to specify the “ingredients” of presentation 171. For example, presentation generation application 160 and/or interface 110 may allow user 103 to specify building blocks 158, for example, using a predefined set of story components customized for storyboard 173 and/or story components defined by user 103. For example, if presentation 171 is to include a multimedia presentation displaying the DVD player product for sale, as discussed above, then user 103 may use a predefined set of story components such as, for example, a product name and model building block, a product price building block, one or more offering building blocks, e.g., coupons, gifts, shipping information, one or more product features building blocks, e.g., size, color, usage, and the like. Presentation generation application 160 may associate media elements 169 with the appropriate building blocks 158, e.g., based on input from user 103, for example, such that a video presenting opening the DVD case and inserting a DVD disk is associated with the building block ‘product usage’.

In some demonstrative embodiments, a building block 158 may be defined based on any suitable input and/or source, e.g., additional to or alternative to user 103. For example, one or more media elements 169 may be directly associated with a building block 158, for example, without receiving specific association information from user 103. For example, application 160 may receive a media element 169 corresponding to a room, e.g., from a capturing device as described above, and automatically associate the “room” media element with a suitable “room” building block.

In some demonstrative embodiments, presentation generation application 160 may perform the operations of receiving media elements 169, selecting theme 175, associating media elements 169 with building blocks 158, and/or generating concrete storyboard 174 and/or any portion thereof according to any suitable order.

In some demonstrative embodiments, presentation generation application 160 may generate presentation 171 by rendering concrete storyboard 174 according to any suitable multimedia rendering algorithm, standard, method, format and/or protocol.

In some demonstrative embodiments, user 103 may opt to save presentation 171 locally, e.g., on user device 102, or remotely, e.g., on storage 153, as part of the video generation service and/or at any other server, storage and/or location. Additionally or alternatively, user 103 may opt to upload presentation 171 to a suitable local network or online file storage server, e.g., from where user 103 may broadcast presentation 171 to an e-commerce site, a content website, web site of user 103, and the like.

In some demonstrative embodiments, presentation generation application 160 may utilize any suitable media analysis algorithm and/or method to analyze one or more of media elements 169, for example, to detect one or more low quality segments and/or high quality segments of an analyzed media element, to detect a scene and/or shot of the analyzed media element, to detect similarities, to detect one or more segments of interests, and the like.

In some demonstrative embodiments, presentation generation application 160 may utilize information and/or conclusions of the media analysis, for example, to better generate presentation 171 and/or to communicate suggestions to the user, helping user 103 in making manual decisions during the process of generating presentation 171.

In some demonstrative embodiments, presentation generation application 160 may perform the media analysis of s media element 169 when the media element 169 is received and/or uploaded, e.g., by user 103, when associating the media element 169 with building blocks 158, e.g., when user 103 sorts and/or tags media 169, during the generation of concrete storyboard 174, and/or as part of any other suitable operation.

In some demonstrative embodiments, application 160 may utilize a set of common video and/or audio analysis filters for performing a plurality of media analysis algorithms. Application 160 may run the filters at the beginning of the media analysis phase and store the results for better performance Application 160 may choose to run these filters at a pre-process phase of the media analysis and to store the results for other more complicated video analysis algorithms that use the results of the histogram or subtraction analysis.

In some demonstrative embodiments, application 160 may run the different media analysis algorithms and/or filters over most or over each of the video frames, seek into key-frames in the video or “jump” a predefined amount of frames between analyses and then conduct a locally extensive analysis in case a problem found or interesting segment was detected.

The specific filters\algorithms used for each stage of media analysis can be customized based on specific implementation needs. In some demonstrative embodiments, the media analysis may include any suitable quality analysis, e.g., as described below.

Common shooting and audio recording mistakes, usually relevant to novice and unskilled videographers and unprofessional to low level recording devices, may cause video footage to look amateur and unprofessional. Quality analysis may help application 160 in making better-automated editing decisions and/or in notifying user 103 of potential media segments that should be cut or enhanced. The media analysis may include any suitable video and/or audio analysis techniques for media analysis.

In some demonstrative embodiments, the quality analysis may include an analysis for a video camera shaking segment, e.g., a video segment where most of the objects move back and forward in the same direction for all or most of the video frames. A shaking video segment may intersect with other types of camera movement such as zoom in\out or panning causing a shaking zoom or shaking panning. For these cases, the movement detection algorithms and video camera shaking segment detection are sensitive for separating major direction movement and noise (shaking). For example, application 160 may use any suitable image analysis algorithms for motion detection, or a combination of motion detection algorithms with specialized shaking segments detection algorithms.

In some demonstrative embodiments, the quality analysis may include an analysis for zoom in\out too fast or too slow. Too fast camera zooming (in or out) is defined as a camera zoom operation with motion velocity that exceeds a predefined value (too slow camera zooming has the opposite definition). The first stage in detecting problematic zoom segments is to detect camera zoom segments, e.g., using any suitable zoom detection algorithm. The velocity of the zooming motion is tested against a predefined minimum and maximum velocity values and in case the actual velocity is out of the allowed range the segment is marked as low-quality zoom segment.

In some demonstrative embodiments, the quality analysis may include an analysis for too slow or too fast camera motion. Too fast camera motion is defined as a motion of most of the objects and pixels between adjacent video frames in a velocity that exceeds a predefined value (too slow camera motion has the opposite definition). The first stage in detecting problematic motion segments is to detect camera motion segments, e.g., using any suitable camera motion/no motion detection and/or camera motion direction detection algorithm. The velocity of the motion is tested against a predefined minimum and maximum velocity values and in case the actual velocity is out of the allowed range the segment is marked as low-quality camera motion segment.

In some demonstrative embodiments, the quality analysis may include an analysis for too fast objects motion. Too fast objects motion is defined as a situation where some of the objects move between adjacent video frames in a velocity that exceeds a predefined value while other objects and background stay still, more or less. Application 160 may use any suitable motion detection algorithms to detect motion segments within adjacent frames and in case motion area is tracked while other areas in the frame are still, application 160 may use any suitable tracking algorithms to keep tracking the moving objects into later frames.

In some demonstrative embodiments, the quality analysis may include an analysis for Ill-lit footage and/or lightning imbalance. Lightning Imbalance may be defined as a drastic variation of luminance between frames of a short video segment, causing an obvious variation in brightness to the human eyes. In imbalanced video segment, some of the frames appear very bright while others appear very dark. Other ill-lit footage types are too dark or too bright frames or segments and too dark or too bright objects or segments within a frame. Application 160 may use any suitable algorithm to examine a luminance of a frame, e.g., distribution of luminance, average luminance, maximum and minimum luminance.

In some demonstrative embodiments, the quality analysis may include an analysis for blurred footage. Blurred images, e.g., in video and/or pictures, are caused by fast motion of the camera, camera out of focus problems and sometimes by foggy environment. Application 160 may implement any suitable edge detection algorithms and/or blur detection algorithms to detect blurry images.

In some demonstrative embodiments, the quality analysis may include an analysis for “Jumping” video segments, e.g., video segments where some of the frames are lost, resulting in a “jumpy” feeling. Application 160 may detect such segments, for example, by scanning the time positions of video frames, locating missing frames (in case the capturing device and the video encoder provides accurate time positions), or by detecting too fast motion between adjacent frames.

In some demonstrative embodiments, the quality analysis may include an analysis for noise segments, e.g., including a random dot pattern, which is superimposed on an image. Application 160 may calculate a peak signal-to-noise ratio (PSNR) for some or all of the video frames and pictures and/or sub segments within the frames. When the PSNR value of a specific frame is below a certain predefined threshold the frame or picture is marked as including noise.

In some demonstrative embodiments, the quality analysis may include an analysis for low resolution segments, which may result in a “pixelated” display, where small single-color square display elements of a bitmap, are visible to the eye. Application 160 may detect low resolution footage, for example, by scanning video frames and pictures pixel by pixel, looking for patterns of “pixelation”. The frame or picture may be marked as having low resolution if, for example, the frame includes several “pixelation” in different positions of the image.

In some demonstrative embodiments, the quality analysis may include one or more audio quality analysis algorithms, e.g., as described below.

In some demonstrative embodiments, the audio quality analysis may include an analysis for background noise, e.g., environmental non-speech sound that disturbs the human ear. Application 160 may implement any suitable background sound detection and/or background noise detection algorithm.

In some demonstrative embodiments, the audio quality analysis may include an analysis for too high or too low power levels and unbalanced power levels. For example, application 160 and/or dynamic storyboard 173 may include suitable specifications for best target sound power range for speech sound. In case of a speech audio segment with power levels below the target range, above the target range or unbalanced power levels application 160 may mark the segment as power level problematic.

In some demonstrative embodiments, application 160 may be implemented to define a weight for each type of quality problem, giving different importance to each of the quality problems.

In some demonstrative embodiments, an output of the quality analysis process may include a set of segments, e.g., marked with start time position and end time position, with a combined quality value and specifications of the detected quality issues.

In some demonstrative embodiments, application 160 may provide an estimation of an effort required for enhancing the quality result, if possible. The effort may be estimated, for example, using estimated running time or CPU cycles. Application 160 may provide an estimated combined weighted quality result of the estimated enhancement algorithms. The combination of the estimated effort required with the estimated enhancement results may provide application with enough information for the decision on whether or not to try and fix a specific media segment in order to include it in presentation 171.

In some demonstrative embodiments, application 160 may implement any suitable scene and shot detection algorithm. A shot may be defined as a segment of video frames that was generated by continuous recording process. A video-scene may be defined as one or more consecutive shots that relate to the same scenery, objects and environment. Application 160 may implement, for example, a combination of suitable shot detection algorithms in order to detect shot boundaries. A scene-boundary detection process may take into consideration the shots order, color variance and color histogram shape of consecutive shots in its decision over scene boundaries, and/or any other suitable parameter. The shot detection process may combine image analysis algorithms with audio signal power and amplitude and background audio noise power and amplitude, e.g., for better detection of shot boundaries. A sudden and abrupt change in audio signal parameters that generates two distinctive audio signal segments may help in describing shot boundaries.

Application 160 may utilize suitable date information, e.g., date and time stamps as may be provided in DV format, to detect shots in a more accurate way. The process of scene detection may also use the date information, combining with other image analysis processes, raising the likelihood that time adjacent shots belong to the same scene.

In some demonstrative embodiments, application 160 may implement any suitable algorithm for detection of similarities. Application 102 may aid user 103 in the process of tagging and attaching media element 169 to building blocks 158 and/or presentation segments, e.g., as described below, by offering user 103 with a graphical indication for similar media elements 169. Accordingly, user 103 may tend less to forget to tag and attach media elements 169 into appropriate building blocks 158. Application 160 may utilize this knowledge, for example, for selecting footage to be rendered into presentation 171, e.g., by preferring the concatenation of similar media elements. The similarity detection process may utilize a combination of video and audio similarities testing based on color variance and color histogram shape and audio signal power and amplitude and background audio noise power and amplitude.

In some demonstrative embodiments, application 160 may implement any suitable algorithm for detection of segments of interest (SOI) and/or segments of no interest (SONI), which may be defined by a start position and end position or in any other suitable manner. The definition of SOI and SONI may be implementation depended and may also be context depended, where the context is the tags and information attached to the analyzed media element. For example, in a ‘Real-Estate Property for Sale’ implementation, camera motion may play a key role in detecting SOI and SONI. Video segments with no camera motion are usually too boring to display a room and therefore may be marked as SONI. However, segments of continues camera movement with the same direction may suggest a panning shoot, which is one of the preferred way to display a room and therefore may be marked as SOL However, in an implementation relating to a talking head scene, such as an agent talking to the camera in front of a property, camera movement may suggest that the analyzed segment is not relevant, and be marked as SONI.

In some demonstrative embodiments, video and/or audio analysis may be used separately and in conjunction to detect SOI and SONI segments. For example, in a talking head type of video, no camera movement, minimal objects movement and continues speech in the foreground segment may be marked as SOI. SOI and SONI segments may also be defined using a minimal or maximal duration. For example, a video clip presenting a property room of less than 2 seconds may be regarded as SONI. Application 160 may combine behavior duration with video and\or audio analysis for better SOI and SONI detection. For example, camera motion may be regarded as significant, e.g., only when continues motion segment of more than 4 seconds is detected.

In some demonstrative embodiments, application 160 may detect the SOI and SONI segments based on camera motion. Camera motion segments may help in revealing the intentions of the videographer, when recording the footage. Application 160 may implement any suitable motion estimation algorithms to estimate the type of motion and its direction, while taking into consideration possible motion noise, e.g., such as camera shaking as described above. The definition for significant and/or insignificant motion may be different between different implementation and therefore the application 160 may allow customizing the minimal significant level for each implementation while providing a default value.

In some demonstrative embodiments, application 160 may detect and/or consider a camera motion of a panning type, e.g., continues camera motion mostly in the same direction for a pre-defined minimum duration. A panning segment can be regarded as SOI, for example, for situations where motion is important for generating interesting video, e.g., in the case of room display in “Real-Estate Property for Sale” implementation; and as SONI, for example, in situations where object motion is more important, e.g., in a product display in “Product for Sale Display” implementation. Motion direction can also play an important role in the decision over SOI segment detection. For example, camera motion up or down may not be regarded as important in the case of room display for “Real-Estate Property for Sale” implementation.

In some demonstrative embodiments, application 160 may detect and/or consider a no camera motion video segment, e.g., a segment of no significant camera motion for a pre-defined minimum duration. The no camera motion segment can be regarded as SONI, for example, for situations where motion is important for generating interesting video, e.g., in the case of room display in “Real-Estate Property for Sale” implementation; and as SOI in situations where object motion is more important, e.g., in the product display in “Product for Sale Display” implementation.

In some demonstrative embodiments, application 160 may detect and/or consider zoom in\out a segment. Camera zoom segments, especially zoom in, may stresses areas of special interest in the eyes of the videographer. Application 160 may implement any suitable algorithms for detection of zoom segments by examining adjacent video frames motion vectors to identify continues motion inward or outward.

In some demonstrative embodiments, application 160 may detect and/or consider object motion within a video segment. Such movement may be regarded as important, for example, when objects move at the foreground of the display. Application 160 may implement any suitable algorithms for detection of object motion and tracking. Object motion may be important, for example, in cases where the viewer should concentrate on objects within the video frames instead of concentrating at the scenery, e.g., in the product display in “Product for Sale Display” implementation. A different definition for significant and/or insignificant object motion may be utilized for different implementations, e.g., customizing a minimal significant level for each implementation while providing a default value. Object motion can be regarded as a significant motion even when only minor motion is detected. For example, in the product display for sale, the user may wish to display internal product features such as, for example, a graphical user interface of a mobile cell phone. The feature display video may cause only small motion while the entire scenery may be pretty still.

In some demonstrative embodiments, application 160 may consider and/or detect a face in a segment. The presence of a person or people in front of the camera can be regarded as important. For example, in a ‘talking head’ or ‘interview’ type of scene the presence of a person or people in front of the camera may be crucial. Application 160 may implement any suitable face detection algorithm for detecting the face segments.

In some demonstrative embodiments, application 160 may consider and/or detect color and/or luminance levels of a segment. In some cases, minimum or maximum levels of luminance and/or color histogram shape or luminance histogram shape may be required. For example, when detection and categorization of indoor and outdoor scenes is important, e.g., to distinguish between garden and view outdoor footage to internal property footage in a “Real-Estate Property for Sale” implementation.

In some demonstrative embodiments, application 160 may consider and/or detect low quality segments. Low quality footage may be regarded as not suitable for display as part of presentation 171. For example, camera shaking video segment that cannot be stabilized properly may be regarded as a SONI segment. Suitable parameters may be defined for marking a low quality segment as SONI. The specifications may include minimum and\or maximum score levels for total quality score and\or separated minimum and\or maximum score levels for one or more of the quality features, e.g., as described above. Each of these scores can relate to the base quality score or to the estimated quality score received after image enhancement.

In some demonstrative embodiments, application 160 may consider and/or detect user's highlighted video and/or audio segments. Application 160 may mark the highlighted segments as SOI segments.

In some demonstrative embodiments, application 160 may implement any suitable audio analysis algorithms for considering and/or detecting the SOI and/or SONI segments.

In some demonstrative embodiments, application 160 may utilize a speech/non-speech detection algorithm. A video segment attached to a speech type audio segment may be regarded as an important media segment. This can be especially true in cases, for example, where ‘talking head’ type of media is required in a scene, or when audio descriptions are acceptable such as, for example, in a product presentation where the presenter accompanies audio descriptions with the visual presentations of the product's features, recording both the audio and video together. Application 160 may implement any suitable speech detection and/or audio classification algorithms. Application 160 may detect and classify the audio speech signals within a segment into background and foreground speech signal, offering the option to remove or reduce background speech signals as background noise.

In some demonstrative embodiments, application 160 may utilize a sentence detection and/or continuous speech detection algorithm. Application 160 may prefer to include full sentences and continues speech or conversation in presentation 171, preventing, as much as possible, cutting media elements in the middle of a sentence, speech or conversation. For example, application 160 may segment speech audio into sentences based on duration of pauses (no signal or low signal). In case the pause segment duration exceeds a predefined threshold, 160 may marks the segment as a sentence. A continues speed segment threshold, may be used to group continuous sentences into a continuous SOI speech segment.

In some demonstrative embodiments, application 160 may allow user 103 to amend and/or modify presentation 171, e.g., in case user 103 is unhappy with presentation 171. For example, application 160 may allow user 103 to manually enhance a media element segment, for example, if application 160 incorporated a media element 169 of low quality without enhancing the media element to a proper degree of enhancement. The enhancement of a media element may include any suitable enhancement operation, e.g., as described above. Additionally or alternatively, application 160 may allow user 103 to replace a selected media element segment. For example, user 103 may instruct application 160 to replace the selected segment at a specific time position of presentation 171, or for all occurrences of the selected segment in presentation 171, with another media element segment. Additionally or alternatively, application 160 may allow user 103 to delete a media element segment, e.g., at a specific time position of presentation 171, or for all occurrences of the segment in presentation 171. Additionally or alternatively, application 160 may allow user 103 to stretch or trim a media element segment, such that a larger segment or smaller segment is generated based on the media element segment. Additionally or alternatively, application 160 may allow user 103 to modify text information by adding, removing or otherwise modifying text information from text segments include in presentation 171. Additionally or alternatively, application 160 may allow user 103 to select a different composition alternative for presentation 171 and/or a scene thereof, e.g., as described below.

In some demonstrative embodiments, application 160 may offer user 103 with any suitable shooting tips and/or shooting guide, e.g., in the form of a document including a checklist of the media elements user 103 should provide and/or guidelines and tips to help a novice videographer in shooting them. User 103 may use the shooting guide document in planning the shooting of media elements 169 and/or avoiding common shooting mistakes. User 103 may use the document checklist to ensure that the required media elements have been captured and/or recorded. The shooting guide and/or shooting checklist may only be a suggested list of instructions, while application 160 may enable user 103 to upload and/or import any media elements. For example, in a ‘Real-Estate Property for Sale’ implementation, the shooting guide may include instructions for recording separate video media files per each room, to ensure that each room video is about 5-10 seconds and that the video is best recorded by panning the video camera around the room. The shooting guide may warn the user not to shoot into a direct source of light, e.g., a window or turned-on lamp, to prevent an abrupt fall of brightness. In a ‘Product for Sale’ platform implementation, the shooting guide may suggest the user to shoot the product from all sides and if possible to rotate it in all directions. Application 160 may be capable of customizing the shooting guide based, for example, on the building blocks 153 of a specific project 181. For example, in a ‘Product for Sale’ implementation, when the user specifies that the product's small size is an important feature, application 160 may suggest to demonstrate the compact size of the product by shooting a ruler measuring the size of the product or by shooting a person inserting the product into his pocket. In a ‘Real-Estate Property for Sale’ implementation, when the user specifies that the property includes a garden, application 160 may suggest to shoot a video of the garden and also to take several pictures of beautiful spots in the garden. The Shooting guide may also include video tutorials and samples, demonstrating the instructions and shooting tips.

In some demonstrative embodiments, dynamic storyboard 173 may include framework logic, for example, in the form of predefined compositions, functions and/or rules, e.g., including and/or score functions as described below, for generating concrete storyboard 174 based on media elements 169 and/or other project-specific data related to project 181. For example, a dynamic storyboard called ‘a quiet stroll in the village’ may include logics for generating a calm and/or soft presentation suitable for presenting real-estate properties on the countryside. According to this example, application 160 may combine the logic of dynamic storyboard 173 with the actual media elements 169, textual information and/or other project data provided by a property owner or a real-estate agent, to create a concrete storyboard 174 for a specific village house property presentation 171.

In some demonstrative embodiments, dynamic storyboard 173 may include a combination of storyboard elements including, for example, multimedia elements 169 (“clips”), effects and/or transitions.

In some demonstrative embodiments, dynamic storyboard 173 may specify, for example, one or more properties for a graphical media element, e.g., one or more of a rectangle or box position (X, Y, Z, Height, Width and depth), X, Y and Z dimension scale, a transparency value (alpha level), rotation, yaw, pitch, roll and other 3D matrix transformations, preserve aspect ratio (meaning, whether dimensional ratios of the original media element are to be preserved for a desired output rectangle), stretch the element to fit (meaning, stretching the original media element or graphics to fit the desired output rectangle) or crop the element to fit the desired output rectangle and playing speed (percentage of the original speed of the media or graphics), and the like. Dynamic storyboard 173 may specify, for example, one or more properties for an audio media element, e.g., one or more of a volume (or power), a playing speed (percentage of the original speed of the audio tracks), and the like.

In some demonstrative embodiments, “effects” may include visual or audio processing techniques that manipulate a single media clip or a combination of a media clip and its effects. The effects may include visual effects, for example, image processing effects, such as blur, glow and motion blur, and the like; image enhancement effects, such as video motion stabilizer, image sharpening, image smoothing, brightness or contrast balancing, histogram equalization and the like; animation effects, such as animated entrance and exit effects of graphics or text segments; video and pictures animations, such as simulating animation of panning and zooming in a picture (known as ken burns effect), video fast forwarding, video slow motioning, and the like. The effects may include audio effect, for example, audio processing effects, such as chorus, compression, distortion, echo, environmental reverberation, flange, gargle, parametric equalizer, waves reverberation, and the like; audio equalizing effects, such as bass, treble setters, and the like, audio enhancement effects, such as speech enhancement effects, e.g., as described herein, automatic equalizer modifiers (based on bass and treble analysis), and the like.

In some demonstrative embodiments, two or more effects may be placed one above the other, e.g., such that each effect processes an output of an underlying effect. For example, a glow effect may wrap a blur effect, which in turn may wrap a video segment clip, such that an output may be generated by first processing the video segment frame to add glow, and then blurring the result of each glowed frame.

In some demonstrative embodiments, “transitions” may be similar to effects in the sense that they are visual or audio processing techniques. However, transitions may manipulate the output of two or more clips, or two or more clips and their associated effects, layered one above the other, for a certain time period. Visual transitions may be one of the SMTPE defined set of transitions or any other suitable industry common transitions, e.g., wipe, dissolve, fade, barn, blinds, gradient wipe, inset, iris, pixelate, radial wipe, random bars, random dissolve, slide, spiral, stretch, strips, wheel, zigzag, and the like, and/or any other customized animation manipulation of the output of two clips. An audio transition may include audio fade, constant gain crossfade (changes audio at a constant rate in and out as it transitions between clips), a constant power crossfade effect (smooth, gradual transition, analogous to the dissolve transition between video clips), and the like.

In some demonstrative embodiments, dynamic storyboard 173 may include one or more predefined storyboard compositions 149. A storyboard composition may be a type of storyboard element, which is a layered placement of storyboard elements over a period of time (“timeline”). The storyboard composition may include a predefined “dynamic” composition to be used by application 160 for generating one or more presentations segments of presentation 171. For example, a composition, e.g., as discussed herein, may include a storyboard composition defining a presentation segment, e.g., segments 202, 204, 206, 208210 and/or 212 (FIGS. 2A-2F). The layers of the composition may enforce a rendering order of the storyboard elements, such that for each frame the storyboard elements are drawn from a lowest layer to an upper layer, one above the other. A layer may include storyboard elements or a combination of storyboard elements and nested or “child” storyboard compositions. An output of a composition may be used as an input for other visual and/or audio effects and transitions.

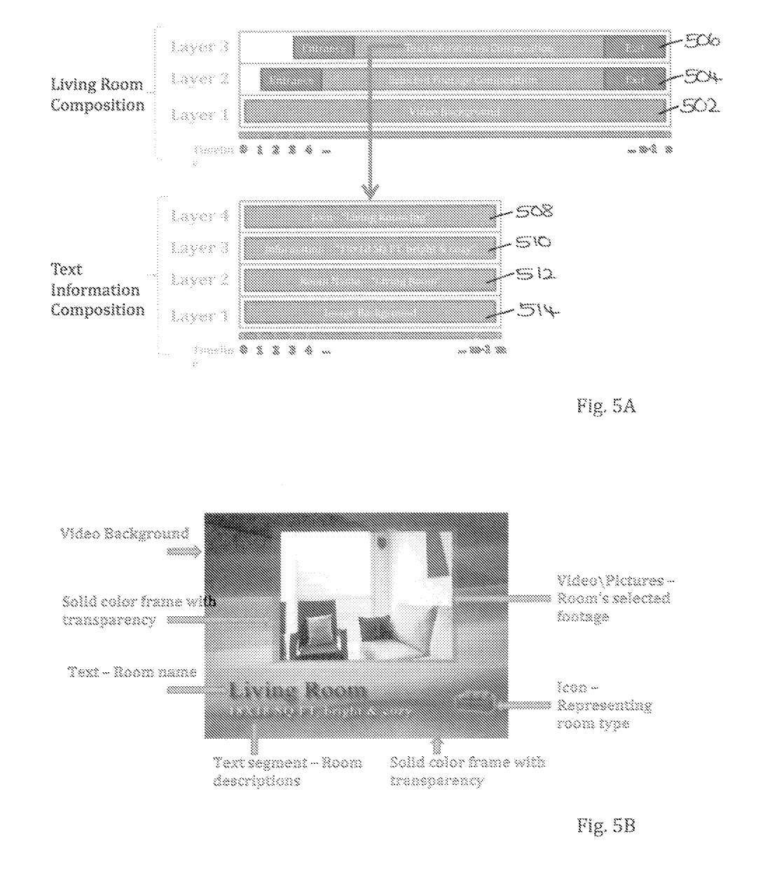

FIG. 5A schematically illustrates a storyboard composition 500, in accordance with some demonstrative embodiments. As shown in FIG. 5A, composition 500 may relate to a specific living room scene within a “Real-Estate Property for Sale” dynamic storyboard implementation. Composition 500 may include three layers, e.g., a first layer 502 to include a video clip to be presented as a background for the scene, a second layer 504 to include a composition of one or more media elements to be presented during the scene, and a third layer 506 to include a composition of textual information relating to the scene. One or more of the layers of composition 500, e.g., layers 504 and/or 506, may also include one or more nested compositions. For example, layer 506 may include a composition of four child layers, e.g., a layer 514 to include an image serving as a background for text layer 506, a layer 512 to include text indicating a name of a room presented by the scene, a layer 510 including textual information relating to the room, and a layer 508 including an icon image representing the type of the room. FIG. 5B illustrates a screen-shot of a presentation segment composed according to the composition of FIG. 5A.

In some demonstrative embodiments, dynamic storyboard 173 may define one or more composition alternatives 154. A composition alternative 154 may include a storyboard composition, which may be selectively included in presentation 171 based on at least one predefined inclusion function 150 and\or at least one predefined score function 151. Inclusion function 150 may be used by application 160 to determine whether or not the composition alternative 154 is to be included as part of presentation 171. Score function 151 may be used by application 160 to evaluate how suitable is the composition alternative 154 for the given situation, e.g., compared to one or more other composition alternatives, as described below. The composition alternative 154 may be regarded, for example, as a recursion structure, e.g., which holds other composition alternatives at all levels and time periods. Dynamic storyboard 173 may define a plurality of competing composition alternatives 154 on a common layer of a parent composition, which may compete over the inclusion or over a best score. Dynamic storyboard 173 may include several competing alternatives 154 for a layer and/or for time period, and application 160 may select a best composition alternative 154 of the competing alternatives, for example, by evaluating the inclusion and/or score functions corresponding to the competing composition alternatives 154.

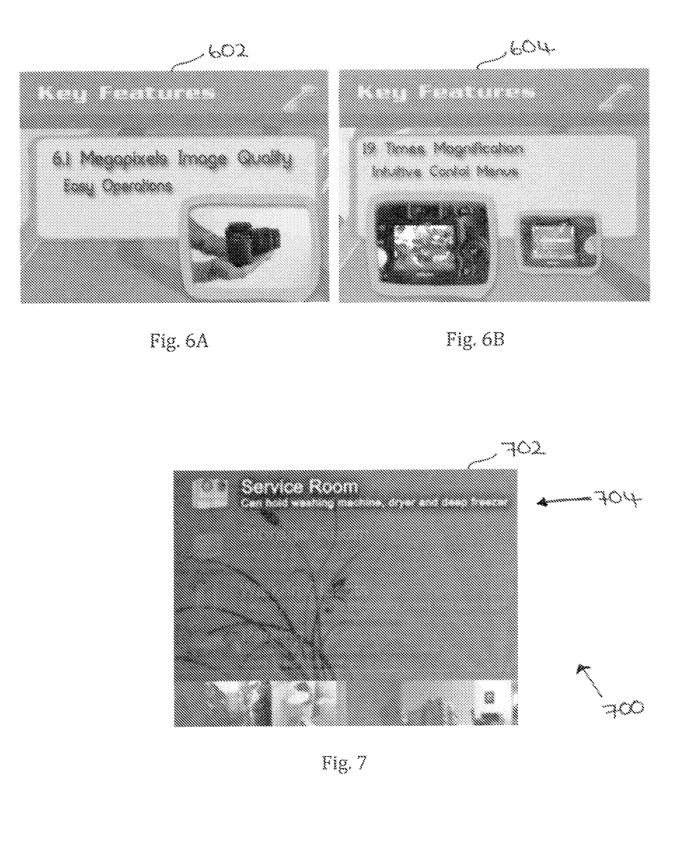

FIGS. 6A and 6B include screen shots of two respective composition alternatives 602 and 604, respectively, in accordance with some demonstrative embodiments. Composition alternatives 602 and 604 relate to a ‘Product for Sale Offering’ dynamic storyboard implementation. Composition alternative 602 is configured to present a single key feature of the product together with related footage. Composition alternative 604 is configured to simultaneously present two features of the product and related footage. Application 160 (FIG. 1) may be capable of selecting between composition alternatives 602 and 604, for example, based on the inclusion and/or score functions defined with respect to composition alternatives 602 and 604. For example, composition alternatives 602 and 604 may define an inclusion function tying the inclusion of composition alternatives 602 and 604 to an importance level of the presented feature, for example, such that composition alternative 602 may be selected for presenting more important features, while composition alternative 604 may be selected for presenting less important features. In another example, the complex inclusion function may take into consideration the number of features to be displayed in the presentation segment, e.g., in order to prevent a very long and tedious presentation of the features. For example, the inclusion function may be defined to select between composition alternatives 602 and 604 based on the number of features to be displayed, for example, such that composition alternative 602 may be selected if no more than a predefined number of important features, e.g., two features, are presented, and all other features are presented using composition alternative 604. The score function may be configured, for example, to balance between video footage quality of a feature, the feature's level of importance, the number of features to be displayed in the presentation segment, the duration of the entire presentation segment, and the like. Each of composition alternatives 602 and 604 may have a different weight for each of the parameters, and application 160 may select the alternative composition having the best score.

In some demonstrative embodiments, inclusion function 150 may include a suitable Boolean type function, e.g., having a result of yes\no. Inclusion function 150 may be defined using any suitable query language, e.g., SQL, XPath, XQuery, and the like.

The inclusion function may be based on one or more parameters, for example, duration parameters, media information parameters, project information parameters, concrete storyboard information parameters, and the like.

The duration parameters may include durations of any defined media element in project 181. For example, the inclusion function may refer to the duration of a specific media element 169, a total duration of all media elements 169, a total duration of media elements 169 associated with a specific building block or set of building blocks, and the like; a duration of SOI or SONI, e.g., for a specific media element or set of media elements associated with a specific building block or set of building blocks; minimal and\or maximal duration of a media element; a total calculated duration of a composition or composition alternative; a total duration of presentation 171 and the like.

The media information parameters may refer to one or more of the media elements imported to project 181, or to one or more media elements associated with a specific tag or set of tags. For example, the inclusion function may refer to quality levels, including all parameters that combines the quality levels (as described above); SOI and SONI parameters (number of segments or any other SOI or SONI parameter described above); tags associated with the clip or clips; the appearance of the clips in the generated presentation 171 (positions, compositions that includes the clips, etc.); and the like.

The project information parameters may refer, for example, to specific tag name or tag names existence; existence of information or specific values (or range of values) for certain building blocks, and the like. For example, a last scene in the ‘Real-Estate Property for Sale’ implementation may include a composition providing a display of business card information of the real-estate agent. The composition inclusion function may include a query for the existence of information regarding at least two of the following: address, phone number and e-mail. In case the information is not sufficient application 160 may not include the business card composition as part of the presentation.

The concrete storyboard information parameters may refer to the current state of the concrete storyboard 174. For example, the inclusion function may be based on an existence of a specific scene or composition; existence of values or specific values (or range of values) for certain elements or compositions (current composition, ancestor composition or any other composition or element in the concrete storyboard); a number of scenes, compositions, elements, and the like.

In some demonstrative embodiments, inclusion function 150 may be defined to have a default implementation, such that application 160 is to include a composition in all situations, e.g., unless a criterion of inclusion function 150 is not met.

In some demonstrative embodiments, the inclusion functions of competing alternatives may be defined in dynamic storyboard 173 using a conditional structure, e.g., (if [first alternative inclusion function is true include this alternative]→else if [next alternative inclusion function is true use the next alternative and so forth]→else [use the last and default alternative]).

In some demonstrative embodiments, the score function 151 may be of a number value type, e.g., integer or floating point, and may be defined and implemented by compiled or interpreted software code or by query language as a weighted combination of one or more of the parameters defined above with respect to the inclusion function. In order to quantify the parameters so that they are eligible for numeric weighted combination application 160 may use the numeric value of a parameter as is. For example, use the brightness level of the video segment as a value in the combined weighted function. Alternatively, application 160 may evaluate sub queries for predefined or calculated values. For example, if the duration of the composition is longer than 10 seconds, then set the value for the duration parameter to 2.

In some demonstrative embodiments, a composition alternative 154 may be defined using a fully-layered composition definition, e.g., as described above with reference to FIG. 5A. Alternatively, a composition alternative 154 may be defined by one or more modifications to a parent composition. For example, instead of providing a full definition composition for each composition alternative 154, a composition alternative may be defined as a set of modifications to a composition ancestor, e.g., by defining changes to specific parameters in a specific time frame. For example, a composition alternative 154 relating to a presentation segment may be defined such that if the composition alternative wins over other alternatives relating to the presentation segment, the composition alternative causes the maximum allowed duration of the presentation segment to be no more than 20 seconds. The modifications may be provided as a query language or a compiled or interpreted software code.

In some demonstrative embodiments, dynamic storyboard 173 may be flexible enough to accommodate a variable number of scenes and/or compositions within the presentation segments, e.g., as described in detail below. For example, in the ‘Real-Estate Property for Sale’ implementation, dynamic storyboard 173 may be configured to accommodate a variable number of rooms according to the number of rooms and their types, as specified by user 103, e.g., as described above with reference to presentation segments 206 and 208 (FIGS. 2C and 2D). In the ‘e-Commerce Product Display’ implementation, dynamic storyboard 173 may be configured to accommodate a variable number of product features within the ‘Product Info’ scene and/or to accommodate a variable number of offering components, e.g., gifts, coupons, and the like, in the ‘Offering’ scene.

In some demonstrative embodiments, dynamic storyboard 173 may utilize one or more storyboard templates 155 to configure portions of dynamic storyboard 173, which may require a variable number of appearances e.g., presentation segments 206 and 208 (FIGS. 2C and 2D). The storyboard template 155 may include a set of rules for generating a plurality of composition alternatives 154. The rules may include a template generator trigger rule. The trigger rule may be defined as a query, for example, using one or more of the query parameters described above with reference to the inclusion function. A result of the trigger query may be a set of records. Each record in the returned record-set may be used as an actual trigger for generating alternatives. Application 160 may loop through the returned record-set, record by record, and application 160 may activate, e.g., for each record, a template initialization process of generating a new instance of alternatives out of the template structure using the current record. The initialization process may include a process of replacing predefined place holders with actual data from the actual trigger record. For example, the ‘e-Commerce Product Display’ implementation may include an ‘offering’ scene configured to present different offering components, e.g., gifts, coupons, and the like. The ‘offering’ scene may be defined as a scene template, having a template generator trigger defined to be a query for all building blocks of the type ‘offering’. A returned record-set may include record-set including gifts, coupons, shipping information, and the like. Application 160 may traverse the returned record set and initialize the scene template ‘offering’, e.g., for each returned record.

In some demonstrative embodiments, the storyboard template 155 may have a recursive structure, allowing child templates to be nested within a parent template. A trigger of a nested template may include subset information of the parent template or a different, e.g., independent query. For example, in the ‘Real-Estate Property for Sale’ implementation, a room display presentation segment, e.g., segments 206 and/or 208 (FIGS. 2C and 2D), may include a text element, e.g., text elements 244, 246, 252 and/or 254 (FIGS. 2C and 2D) describing a presented room. According to this example, a room scene template may include a nested template for displaying text description information. The template generator trigger for the scene template may include the list of rooms specified by user 103; and/or the template generator trigger for the nested template of the text description elements may include a list of text descriptions associated with each room. Application 160 may initialize each room, using the scene template, and then initialize each text description associated with the current generated room.

In some demonstrative embodiments, elements of composition alternatives generated using the template trigger may relate and/or refer to previously generated composition alternatives, for example, alternatives generated by previous records of the trigger. The elements may refer to any parameter and/or value of previously generated alternatives, for example, to time positions of previously elements, effects and transitions.

Reference is made to FIG. 7, which includes a screen-shot illustration of a presentation segment 700 composed according to a storyboard template, in accordance with some demonstrative embodiments. As shown in FIG. 7, the storyboard template may include a scene template ‘Rooms with no footage’, which may be implemented as part of a ‘Real-Estate Property for Sale’ presentation. The template may include a generator trigger querying over building blocks 158 (FIG. 1) and media elements 169 (FIG. 1), looking for room building blocks with no media files attached to them. For example, building blocks 158 (FIG. 1), e.g., as defined by user 103 (FIG. 1), may include six rooms with no footage attached. Each of the six rooms may be used as a trigger to generate an entrance in the rooms-with-no-footage template. The template may include a single composition alternative with a first text segment element 702 including a “room name” place holder and the second text segment element 704 including a “room description” place holder. As shown in FIG. 7, when initializing the composition alternative for each actual trigger, e.g., for each room building block, application 160 (FIG. 1) may replace the place holders with real and actual data from the trigger information, e.g., replacing place holder 702 with the actual and current room name, and/or replacing place holder 704 with the actual and current room name. As shown in FIG. 7, the composition alternative may include, for example, one or more effects, for example, fade-in and/or fade-out effects, over the text segments, generating a visual focus on one room description at a time, such that the description of rooms is highlighted one by one from top to bottom. The fade-in and fade-out effects refer to effects of the previous generated “room” composition. Each time a room gets a focus, the fade-in effect is activated for the focused room and the previous focused room activates the fade-out effect. The composition alternatives text elements of FIG. 7 may refer to each other, e.g., to a previously generated. For example, each generated composition is positioned a predefined number of pixels below the bottom border of a previous generated composition.

Referring back to FIG. 1, in some demonstrative embodiments, the template 155 may be configured to selectively modify the duration of a composition generated by the template 155, e.g., by extending the total duration of the composition and/or reducing the total duration of the composition, e.g., as described below.

In some demonstrative embodiments, dynamic storyboard 173 may be implemented as a storyboard template 155. Dynamic storyboard 173 may include nested templates, for example, in the form of the storyboard scene templates and/or other nested templates and alternatives representing the graphical and logical behavior of each presentation segment. For example, dynamic storyboard 173 relating to a Real-Estate property for sale may include an introduction scene template, for example, a scene introducing the realtor presenting the property and property information; a room display scene template, for example, presenting room video, pictures and text information; and a summary scene template, for example, presenting property summary information and realtor business card information. Concrete storyboard 174 may be generated based on dynamic storyboard 173 for a specific property with a kitchen and a bedroom may include at least one introduction scene, e.g., segments 202 and/or 204 (FIGS. 2A and 2B), a kitchen display scene, e.g., segment 206 (FIG. 2C), a kitchen display scene, e.g., segment 208 (FIG. 2D), and at least one summary scene, e.g., segments 210 and/or 212 (FIGS. 2E and 2F).

In some demonstrative embodiments, dynamic storyboard 173 may be configured to allow application 160 to determine the time-composition, e.g., in terms duration and/or time positioning, of the elements to be included in concrete storyboard 174, e.g., as described below.

In some demonstrative embodiments, dynamic storyboard 173 may be configured to enable any suitable time-position settings for a storyboard element, e.g., as described below.

In one example, dynamic storyboard 173 may be configured to enable setting a fixed time position and/or duration for a storyboard element, for example, by setting a fixed start position and/or end position, e.g., relative to a starting time of a parent composition alternative. For example, in a ‘Sell Offering’ Scene template of a product for sale presentation, a graphical element of a “star” icon image, highlighting the product price, may be set to appear 1 second after the starting of the scene and to be displayed for 5 seconds.

In another example, dynamic storyboard 173 may be configured to enable setting a position and\or duration for the storyboard element relative to the end time position of the composition alternative. For example, until application 160 completes to generate the concrete storyboard elements out of the composition alternative, the actual duration and end time position of the composition is not known. The storyboard element start time position and\or end time position may be attached to the end time position of the composition alternative. Application 160 may set the actual start and end time of the storyboard element, for example, while setting and calculating the actual duration of the composition or right after setting and calculating the actual duration of the composition, e.g., as described below. For example, in a room display scene template of a real-estate property for sale presentation, a text segment graphical element including the name of the currently displayed room may be attached to the start time position and end time position of the concrete presentation segment, such that the text will be displayed for the entire scene duration. For a ‘Living Room’ Concrete segment including a video footage having a duration of 10 seconds, application 160 may set the concrete segment duration to be 10 seconds and, therefore, set the ‘Living Room’ text segment to start at 0 seconds within the segment and end at 10 seconds. The storyboard element start position and/or end position may differ from the concrete segment end position. For example, a graphical element may be set to start 3 seconds before the end position of a corresponding segment.

In another example, dynamic storyboard 173 may be configured to enable setting a position and\or duration of a storyboard element relative to another graphical element, e.g., allowing the time-wise attachment of graphical elements. Dynamic storyboard 173 may allow elements to specify their start time position, end time position and/or duration with reference to other elements. The actual and concrete time positions and durations may be realized while application 160 generates concrete storyboard 174. In one example, the relative attachment may include a start and stop position reference. For example, the start and\or end position of a storyboard element may refer to the start and/or end time position of another element. Each of the positions may refer to another element. The time reference of the storyboard element may refer to the starting or ending position of the referred element. For example, a room display scene may include a text area displaying the comments about the room and a video\footage area, displaying the relevant footage. In order to define the situation where at the first room scene instance the text area enters the scene right after the video\footage enters the scene, the storyboard element of the text area start position may refer to the ending position of the storyboard element of the video\footage area.

Additionally or alternatively, the time reference of the storyboard element may refer to the duration of another element, e.g., by defining a first element may have the same duration as a second referred element. The concrete and actual duration of the element may differ by up to defined ‘duration reference difference’ value, which may be defined by dynamic storyboard 173.

Additionally or alternatively, the time reference of the storyboard element may include a “do not exceed start and do not exceed stop” reference, e.g., defining a current element stop position must precede the starting position of a referenced element by a ‘do not exceed start delta’ value, which may be defined by dynamic storyboard 173; and/or defining the current element stop position must precede the stop position of the referenced element by a ‘do not exceed stop delta’ value, which may be defined by dynamic storyboard 173.

In another example, dynamic storyboard 173 may be configured to enable setting a minimum and/or maximum duration specifying the allowed minimum duration and/or allowed maximum duration of the storyboard element. In case no minimum or maximum durations are specified on the storyboard element, a default minimum duration, e.g., 0, and/or a maximum duration, e.g., infinite time, may be used.

In another example, dynamic storyboard 173 may be configured to enable setting a preferred duration specifying the preferred duration of the storyboard element. The preferred duration may be used, for example, when the preferred duration value falls within the range of the allowed minimum duration and the allowed maximum duration, and application 160 may set the duration of the storyboard element to the preferred duration value.

In some demonstrative embodiments, application 160 may generate concrete storyboard 174 based on dynamic storyboard 175, for example, as described in detail below.

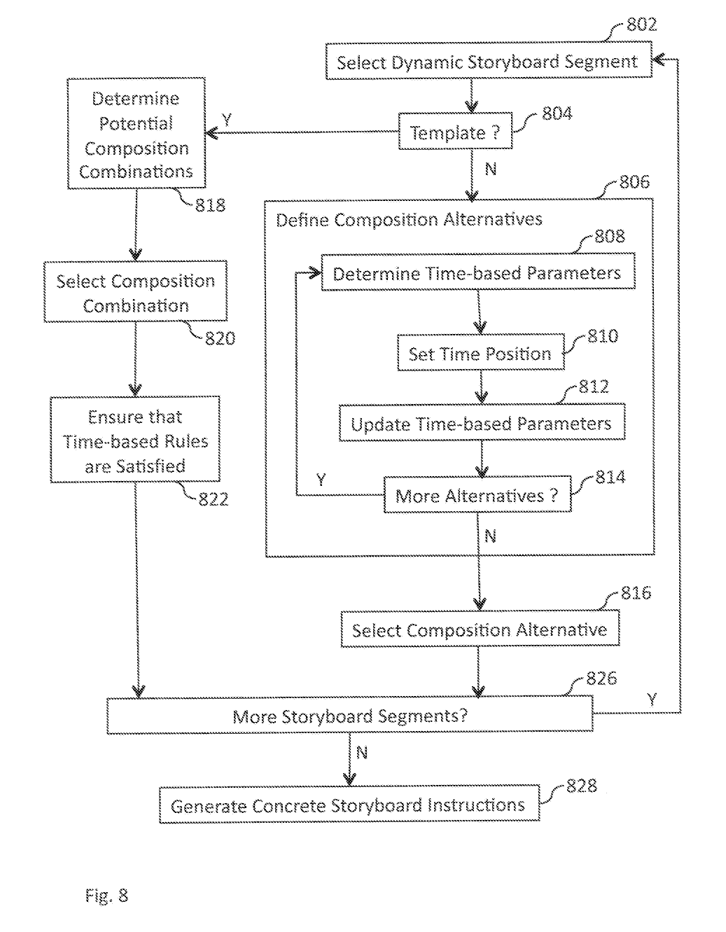

Reference is made to FIG. 8, which schematically illustrates a method of generating a concrete storyboard, in accordance with some demonstrative embodiments. One or more of the operations of the method of FIG. 8 may be performed by a video generation application e.g., application 160 (FIG. 1) and/or any other suitable application and/or service, to generate a concrete storyboard, e.g., concrete storyboard 174 (FIG. 1), based on a dynamic storyboard, e.g., dynamic storyboard 173 (FIG. 1).

As indicated at block 802, the method may include selecting a dynamic storyboard presentation segment to be processed, for example, according to an order defined by the dynamic storyboard. For example, application 160 (FIG. 1) may “walk” the dynamic storyboard compositions 149 (FIG. 1) and templates 155 (FIG. 1), level by level, e.g., by processing an introduction segment, a feature segment and a closing segment, e.g., as described above with reference to FIGS. 2A-2F.

As indicated at block 804, the method may include determining whether or not the selected segment relates to a template.

As indicated at block 806, the method may include defining one or more potential composition alternatives to be considered with respect to the selected segment, e.g., if the selected segment does not refer to a template. For example, application 160 (FIG. 1) may determine a time-based composition of each of the composition alternatives, e.g., as described below.

In some demonstrative embodiments, application 160 (FIG. 1) may resolve the time positions and/or duration of each storyboard element of a composition alternative, for example, while application 160 (FIG. 1) generates the composition alternative. Application 160 (FIG. 1) may processes the storyboard elements, for example, by order of precedence. For example, application 160 (FIG. 1) may sort the storyboard elements, e.g., according to the referred time position elements. The first elements to be processed may include the story elements, which do not refer to any other element time-wise. Such sorting process may ensure, for example, that a storyboard element is processed before processing all other storyboard elements, which refer to one or more time positions of the storyboard element being processed. Elements of the same precedence may be processed according to any suitable criteria, for example, according to the order of appearance in dynamic storyboard 173 (FIG. 1), according to a priority value that may be defined by dynamic storyboard over one or more of the elements, and/or any other criterion.

In some demonstrative embodiments, application 160 (FIG. 1) may set the end position of the composition alternative, for example, after resolving all the time positions of all the storyboard elements of the composition alternative. Consequently, a “waterfall” of updates may be triggered for all elements having start and\or end positions, which are attached to the end position of the composition alternative.

As indicated at block 808, in some demonstrative embodiments defining the composition alternatives may include determining one or more time-based parameters, e.g., a minimum allowed duration, a maximum allowed duration, and the like, of a storyboard element corresponding to the composition alternative.

In some demonstrative embodiments, dynamic storyboard 173 (FIG. 1) may define minimum duration and\or maximum duration values. Accordingly, application 160 (FIG. 1) may initialize the maximum duration and minimum duration of the storyboard element based on the values defined by dynamic storyboard 173 (FIG. 1).

In some demonstrative embodiments, dynamic storyboard 173 (FIG. 1) may define an absolute start time position and\or an absolute stop time position. Accordingly, application 160 (FIG. 1) may initialize the start time and end time positions of the storyboard element based on the values defined by dynamic storyboard 173 (FIG. 1).

In some demonstrative embodiments, dynamic storyboard 173 (FIG. 1) may define an absolute a fixed duration. Accordingly, application 160 (FIG. 1) may initialize the minimum and maximum durations of the storyboard element based on the fixed duration defined by dynamic storyboard 173 (FIG. 1).

In some demonstrative embodiments, the storyboard element may reference the start and/or stop position of one or more other elements. Accordingly, application 160 (FIG. 1) may set the start time position and\or end time position of the storyboard element according to the referenced time positions.

In some demonstrative embodiments, e.g., if the duration of the storyboard element is not set and the storyboard element refers to the duration of another element, application 160 (FIG. 1) may set the duration of the storyboard element to be the referred duration or to the referred duration with addition of a difference value. Additionally or alternatively, application 160 (FIG. 1) may ensure that the referred duration refereed to by the storyboard element is of the same length of a calculated duration of the storyboard element. Otherwise, application 160 (FIG. 1) may determine that the composition alternative cannot be generated.

In some demonstrative embodiments, e.g., if the duration of the storyboard element is not set and the storyboard element refers to the duration of another element for ‘do not exceed start’, application 160 (FIG. 1) may determine the maximum duration of the storyboard element to be the minimum duration between the calculated maximum duration and a duration resulting from a difference between the start position of the storyboard element and the start position of the referenced element.

In some demonstrative embodiments, e.g., if the duration of the storyboard element is not set and the storyboard element refers to the duration of another element for ‘do not exceed stop’, application 160 (FIG. 1) may determine the maximum duration of the storyboard element to be the minimum duration the calculated maximum duration and a duration resulting from a difference between the start position of the storyboard element and the stop position of the referenced element.

In some demonstrative embodiments, application 160 may set the maximum duration for the storyboard element to be the minimum duration between the calculated maximum duration and a current maximum duration of the composition alternative, which may be calculated, e.g., together with a minimum duration of the composition alternative. The maximum and minimum durations of the composition alternative may be initialized based on values defined by dynamic storyboard 173, and updated based on the storyboard elements of the composition alternative.

As indicated at block 810, in some demonstrative embodiments defining the composition alternatives may include setting the time position of the storyboard element, e.g., based on the calculated time-based parameters.

In some demonstrative embodiments, application 160 (FIG. 1) may set the duration of the storyboard element to a preferred duration value, e.g., if the preferred duration is specified and falls within the range of the minimum duration and maximum allowed durations.

In some demonstrative embodiments, application 160 (FIG. 1) may set the duration of the storyboard element to be the minimum duration or the maximum duration, e.g., based on any suitable criteria, e.g., dynamic storyboard 173 (FIG. 1) may define that the minimum duration is to be selected, that the maximum duration is to be selected, that one of the minimum and maximum durations is to be selected, e.g., randomly or based on any suitable selection function, and the like.

In some demonstrative embodiments, a default rule regarding the calculation of duration may be selectively overridden with respect to a storyboard element, e.g., based on special knowledge and/or behavior of the storyboard element. For example, the calculation of the duration of a video selection element may override a default calculation process, e.g., in a way that takes into consideration a length of the raw video footage or, for example, considers a best quality continuous segment length when deciding over the duration length value.

As indicated at block 812, in some demonstrative embodiments defining the composition alternatives may include updating durations of the composition alternative including the storyboard element.

In some demonstrative embodiments, application 160 (FIG. 1) may set the minimum duration of the composition alternative to be the difference between end position of the storyboard element and the starting position of the composition, for example, if the end position of the element exceeds the sum of the start position of the composition and the current minimum duration of the composition.

In some demonstrative embodiments, application 160 (FIG. 1) may set the end position of the composition to be the end position of the storyboard element, for example, if the element is attached to the end of the composition and the end position of the element exceeds the end position of the composition.

In some demonstrative embodiments, application 160 (FIG. 1) may update the other elements that refer to the currently processed element with the determined time-position parameters of the currently processed element. The other elements may re-generate and/or update the durations and/or graphic parameters, e.g., based on the determined time-position parameters of the currently processed element.

As indicated at block 814, the method may include repeating the operations of blocks 808, 810 and/or 812 with respect to one or more other composition alternatives.

As indicated at block 816, the method may include selecting a winning composition alternative. For example, application 160 (FIG. 1) may select a winning alternative from the set of valid alternatives that passed the corresponding inclusion function test, e.g., as described above. A composition alternative may pass the inclusion function test, while still failing to pass the minimum duration and/or maximum duration requirements and/or or any other internal element requirements, e.g., minimum footage quality requirement of a sub-element, of the composition alternative.

In some demonstrative embodiments, the winning composition may be selected based on any suitable criterion, for example, selecting the composition alternative having the highest score, the lowest score, and the like. Application 160 (FIG. 1) and/or dynamic storyboard 173 (FIG. 1) may include a definition for an equal score range, defining a range of scores as equal. Application 160 (FIG. 1) may select the winning composition alternative, e.g., randomly, from between a plurality of composition alternatives having a score within the equal score range.

In some demonstrative embodiments, none of the composition alternatives may comply with the inclusion function, with the minimum duration and/or maximum duration restrictions, and/or with internal elements requirements. In some embodiments, dynamic storyboard 173 (FIG. 1) may include a set of one or more easing operations corresponding to the composition alternatives. Application 160 (FIG. 1) may run the easing operations over the inclusion function, the minimum duration and/or maximum duration restrictions, and/or the internal elements requirements, and re-check the composition alternatives. The easing operations may include any set of modifications to any parameter relating to the query parameters described above. Dynamic storyboard 173 (FIG. 1) may include more than one set of easing operations. For example, application 160 (FIG. 1) may run the sets of easing operations, e.g., one by one, for example, until reaching a situation where at least one of the composition alternatives passes the inclusion function test.

As indicated at block 818, the method may include defining one or more potential combinations of concrete compositions (“composition combinations”) based on the selected segment, e.g., if the selected segment refers to a template. For example, application 160 (FIG. 1) may determine a plurality of composition combinations based on building blocks 158 (FIG. 1) and composition alternatives 154 (FIG. 1) with respect to the rules of template 155 (FIG. 1). For example, the template may include a “features scene” for presenting a product for sale, relating to composition alternatives 602 (FIG. 6A) and 604 (FIG. 6B) for presenting features of the product for sale. Application 160 (FIG. 1) may determine a first composition combination including one or more concrete compositions, based on building blocks 158 (FIG. 1) relating to the features of the product, according to composition alternative 602 (FIG. 6A); and a second composition combination including one or more concrete compositions, based on building blocks 158 (FIG. 1) relating to the features of the product, according to composition alternative 604 (FIG. 6B). For example, if building block 158 (FIG. 1) include six feature building blocks relating to six features of the product, respectively, then the first composition combination may include a sequence of six presentation segments composed according to composition alternative 602 (FIG. 6A), e.g., wherein each segment presents a respective one of the six feature building blocks; and the second composition combination may include a sequence of three presentation segments composed according to composition alternative 604 (FIG. 6B), e.g., wherein each segment presents a respective pair of the six feature building blocks. Application 160 (FIG. 1) may determine the composition combination by performing one or more operations analogous to the operations described above with respect to the operation of defining the composition alternatives, e.g., as described above with reference to block 806.

As indicated at block 820, the method may include selecting between the composition combinations. For example, application 160 (FIG. 1) may select a winning composition combination from the first and second composition combinations, for example, based on one or more selection rules defined by dynamic storyboard 173 (FIG. 1) and/or template 155 (FIG. 1). For example, application 160 (FIG. 1) may select the winning composition combination by performing one or more operations analogous to the operations described above with respect to the operation of selecting the winning the composition alternative, e.g., as described above with reference to block 816.

As indicated at block 822, the method may include ensuring that the winning composition combination complies with time-based rules defined by the template. Template elements may be constrained, for example, for time positions and allowed duration range as for any other type of element. The template duration constrain may require that the total duration of the winning composition combination, e.g., from start time position of the earliest composition to the end time position of the latest composition of the composition combination, is to comply with a template allow duration range.

In some demonstrative embodiments, application 160 (FIG. 1) may adjust the durations of the compositions, e.g., if duration of the generated template does not comply with its allowed duration range. For example, application 160 (FIG. 1) may ‘stretch’ and/or ‘squeeze’ the durations of the generated compositions and their elements, e.g., within the allowed duration range of each element, until reaching a duration within the template allow duration range.

In some demonstrative embodiments, application 160 (FIG. 1) may adjust the template duration using a template extender or reducer, for example, if the compositions cannot be adjusted to comply with the template allow duration range. Template extenders and reducers can act as template by themselves, using the same original template trigger query or using a different one. For example, in a footage selection template, e.g., as described below, application 160 (FIG. 1) may concatenate the rendering of videos, pictures and audio tracks separating them by video and audio transitions. In case the template generated duration extends the allowed range or is below the allowed range, application 160 (FIG. 1) may extend or reduce the total durations of the generated media segments by applying a suitable extender or reducer template.

In some demonstrative embodiments, an extender template may re-render videos, pictures and/or audio generated by the trigger query until reaching a duration within the allowed duration range; may select small “good” quality and or SOI video segments from within video clips generated by the trigger, and repeat their rendering until reaching duration within the allowed duration range may extract “good” quality or SOI video frames as pictures, and render picture animation effects over the extracted pictures; and/or may perform any other suitable “extraction” operation to prolong the duration of the template. The extenders and/or reducers may include independent templates, which may define different types of effects and/or transitions than the ones that appear in the original template being extended or reduced.

As indicated at block 826, the method may include repeating the operations of blocks 802, 804, 806, 816, 818, 820 and/or 822 for one or more additional segments defined by the dynamic storyboard. For example, application 160 (FIG. 1) may “walk” the dynamic storyboard compositions 149 (FIG. 1) and templates 155 (FIG. 1), level by level, e.g., by processing an introduction segment, a feature segment and a closing segment, e.g., as described above with reference to FIGS. 2A-2F.

As indicated at block 828, the method may include generating concrete storyboard instructions. For example, application 160 (FIG. 1) may generate instructions of concrete storyboard 174 (FIG. 1), e.g., including the elements to display and their absolute time positions and duration. The instructions of concrete storyboard 174 (FIG. 1) may then be rendered into the presentation 171 (FIG. 1).

Referring back to FIG. 1, in some demonstrative embodiments, application 160 may select media elements 169 and/or any part thereof to be displayed in presentation 171, e.g., by applying any suitable footage selection algorithm, as described below.

In some demonstrative embodiments, the footage selection algorithm may be considered and/or implemented as a type of storyboard template (“the footage selection template”), for example, a template 155 defining one or more composition alternatives 154 configured for displaying relevant footage, e.g., video, pictures and\or audio, according to the quality and/or other classification and/or selection of the footage.

In some demonstrative embodiments, the footage selection template may include a template trigger query, which is to query media elements 169, building blocks 158, media analysis information, for example, segments of information, quality level, required enhancement scores and the like as discussed above with reference to the analysis of media elements 169, and/or any other suitable information, for example, usage of a segment in other positions of presentation 171, e.g., to prevent extensive usage of good quality and/or interesting segments. A resulting triggered record-set may include records of media segments. The footage selection template may be generated for one or more of the records, e.g., for each media segment of the records.

For example, a footage selection template configured for displaying footage of a room in a “Real-Estate Property for Sale” implementation may be defined in a way that the application 160 renders media elements 169 relevant to the same room, e.g., pictures and/or video segments displaying the same room, one after the other, with any suitable effect, e.g., by separating two adjacent media elements using a suitable fade transition. An allowed duration range of a media element may be defined, for example, to be between 3-10 seconds, e.g., with a preferred duration of 5 seconds for pictures, and/or application 160 may add a suitable effect, for example, a panning and zooming effect, e.g., a ken burns effect, for each picture rendering. In one example, media elements 169 may include a video segment of 9 seconds and a corresponding picture relating to a “study room”. Accordingly, the footage selection template may result in video rendering of 9 seconds, which is within the allowed duration range, followed by a fade transition into a paned and zoomed picture for another 5 seconds, e.g., according to the preferred duration.

In some demonstrative embodiments, application 160 may implement a suitable video-segment selection algorithm and/or method for selecting one or more video segments, e.g., out of media elements 169, and/or determining the duration of the selected video segments to be rendered as part of presentation 171. The video-segment selection algorithm may be based on any suitable information relating to media elements 169, for example, information about an analyzed media element 169 resulting from the media analysis described above, e.g., SOI and SONI segments and/or quality analysis.

In some demonstrative embodiments, application 160 may apply the video-segment selection algorithm with respect to a media element 169 including video. An output video-segment selection algorithm may include a string of sub-segments, separated by predefined visual transitions. The video-segment selection algorithm may be restricted by the element allowed duration range, as described above. For example, a total duration of the string of sub-segments of a media element may be restricted to comply with the allowed duration range of the element.

In some demonstrative embodiments, the video-segment selection algorithm may be configured to generate the string of sub-segments including a longest possible time continuous combination of segments of a video element, e.g., including the entire video element.

In some demonstrative embodiments, application 160 may define a minimum allowed duration value for a valid sub-segment. Application 160 may not include in the sting of sub-segments a segment having a duration below the minimal duration value. In some embodiments, the minimum duration value may be overridden by one or more rules of storyboard 173.

In some demonstrative embodiments, application 160 may select to include the entire video footage of a video element as part of a storyboard element, for example, if no SOI or SONI sub-segments are detected in the video element and the duration of the entire video element is within the allowed duration of the storyboard element.

In some demonstrative embodiments, if no SONI sub-segments are detected in the video element while one or more SOI sub-segments are detected, application 160 may determine whether the entire video element or only the SOI segments are to be included in the selected footage, for example, based on any suitable criterion.

In some demonstrative embodiments, if one or more SONI sub-segments and\or ‘not to be rendered’ sub-segments are detected, application 160 may trim and\or remove the SONI and\or ‘not to be rendered’ sub-segments, and generate a string of the remaining sub-segments. Application 160 may select the string of remaining sub-segments, for example, if the string of remaining sub-segments complies with the allowed duration range.

In some demonstrative embodiments, if the duration of the string of selected sub-segments exceeds the allowed duration range, application 160 may trim and\or remove non-SOI sub-segments, for example, one by one, e.g., sorted by time position, quality levels, quality enhancement estimations, effort, a combination thereof and/or any other suitable criteria, for example, until the duration of the remaining string of sub-segments is within the allowed duration range.

In some demonstrative embodiments, if the duration of the remaining string of sub-segments, e.g., after removing the non-SOI sub-segments, still exceeds the allowed duration range, application 160 may trim the SOI sub-segments and/or other sub-segments, e.g., in case no SOI segments are present, for example, e.g., sorted by time position, quality levels, quality enhancement estimations, effort, a combination thereof and/or any other suitable criteria, for example, until the duration of the remaining string of sub-segments is within the allowed duration range.

In some demonstrative embodiments, if the duration of the string of sub-segments still exceeds the allowed duration range, application may perform any suitable operation, for example, by selecting one or more of the sub-segments according to any criterion, to reduce the duration of the string of sub-segments until the duration of the remaining string of sub-segments is within the allowed duration range. If the duration of the string of sub-segments is below the allowed minimum duration, application 160 may perform any suitable operation, for example, by stretching one or more of the sub-segments, e.g., as described herein, to increase the duration of the string of sub-segments until the duration of the remaining string of sub-segments is equal to or above the allowed minimum duration.

In some demonstrative embodiments, application may determine that a media segment, which was detected as a segment having low quality or as quality problematic segment. Application 160 may opt to enhance or to conceal the problematic segment, e.g., as described below.

In some demonstrative embodiments, problematic segments of a video element may be concealed, for example, by extracting high-quality pictures and/or high-quality continuous video segments of the video element. Dynamic storyboard 173 may include, for example, one or more selection criteria for application 160 to select and/or extract the high-quality sub-segments. The selection criteria may include, for example, a minimal quality score, e.g., a compound score and\or separated minimal scores for one or more of the quality parameters described above; a minimal video sub-segment duration; a maximal number of extracted segments and/or pictures; a minimal time difference between adjacent extracted frames, and the like.

In some demonstrative embodiments, dynamic storyboard 173 may specify a storyboard template for grouping and processing the extracted segments. For example, a ‘Real-Estate Property for Sale’ dynamic storyboard 173 may include a low-quality segments graphical concealing template to be used by application, for example, if video footage of a room display is of low quality. The low-quality segments graphical concealing template may be configured to join the pictures and/or videos using predefined video transitions, e.g., as fade, and/or simulating panning and zooming for the extracted pictures as a way to generate a more interesting motion. The low-quality segments graphical concealing template may also include, for example, image and/or video enhancements and/or any other visual effects over the extracted segments.

In some demonstrative embodiments, application 160 may opt to use the low-quality segments graphical concealing template, for example, before or instead of trying to enhance a video segment using other enhancement algorithms, or only when the other enhancement algorithms fail to provide a required minimal quality. In one example, application 160 may have a predefined criterion for selecting whether to apply the low-quality segments graphical concealing template and/or other enhancement algorithms, e.g., such that concealing may be performed for one or more types of the known quality problems. In some embodiments, this criterion may be overridden by one or more rules of storyboard 173.

In some demonstrative embodiments, application 160 may utilize any suitable visual quality based editing algorithms, for example, based on a type of quality problem of a video segment to be enhanced. In one example, the video footage may be affected by camera shaking. Application 160 may stabilize a video segment having camera shaking, e.g., using any suitable video enhancement algorithms for stabilizing a short segment of shaking video frames; and/or by concealing the low-quality graphical video segments, e.g., using the concealing algorithm described above. In another example, the video footage may suffer from a too fast or too slow zooming Application 160 may adjust a zooming speed of a video segment, e.g., having a too fast or too slow zooming in or zooming out. For example, if the zoom-in\out segment is too fast, application 160 may interpolate new zoomed frames between adjacent frames to produce a slower motion, for example, if the motion of the entire zoom segment is roughly the same and the motion is more or less clean of noise motion, such as shaking camera motion. If, for example, the zoom-in\out segment is too slow, application 160 may increase the speed of the zooming by deleting one or more frames of the video footage to generate a fast motion, for example, if the motion of the entire zoom segment is roughly the same and the motion is mostly clean of motion noise, such as shaking camera motion. Additionally or alternatively, application 160 may conceal the low-quality graphical video segments resulting from the zooming, e.g., using the concealing algorithm described above. In another example, the video footage may suffer too slow or too fast camera motion and/or too fast objects motion. Application 160 may increase the speed of the motion, for example, by deleting frames and/or application 160 may reduce the speed of motion, for example by duplicating frames, e.g., if the motion speed of the entire segment is roughly the same and the motion is mostly clean of motion noise, such as shaking camera motion. Additionally or alternatively, application 160 may conceal the low-quality graphical video segments resulting from the speed of motion, e.g., using the concealing algorithm described above. In another example, the video may include “Jumping” video segments. Application 160 may reduce the motion of the video segments, e.g., as described above, to visually enhance video segments with lost frames. Additionally or alternatively, application 160 may conceal the low-quality graphical video segments resulting from lost frames, e.g., using the concealing algorithm described above. In another example, the video footage may include blurry footage. Application 160 may implement any suitable de-blurring and/or sharpening image-processing algorithms to reduce and/or eliminate the blurriness. In another example, the video footage may include ill lit footage and/or footage having lightning imbalance. Application 160 may implement any suitable lightning enhancement algorithms and/or the concealing algorithm described above. In another example, the video footage may include low-resolution segments. Application 160 may utilize any suitable resolution enhancement algorithms, e.g., suitable super-resolution algorithms, smoothing algorithms, sharpening algorithms and/or any combination thereof. Additionally or alternatively, application 160 may utilize the concealing algorithm described above. In another example, the video footage may include noise segments. Application 160 may utilize any suitable noise reduction algorithms and/or the concealing algorithm described above.

In some demonstrative embodiments, application 160 may utilize any suitable audio quality based editing algorithms, for example, to enhance an audio and/or video element. In one example, application 160 may utilize any suitable background noise algorithms, e.g., to reduce a background noise. In another example, application 160 may adjust too high or too low power levels and/or unbalanced power levels, for example, by balancing and/or equalizing sound power levels, for example, based on a target sound power range of speech sound, e.g., which may be defined by dynamic storyboard 173.

In some demonstrative embodiments, application 160 may incorporate any suitable advertisement (ad) information into presentation 171. For example, application 160 may be configured to incorporate context-sensitive ads into presentation 171, for example, based on a context of media elements 169, building blocks 158, compositions 149, information received from user 103 and/or any suitable information. In one example, application 160 may incorporate an ad into a presentation segment of presentation 171 based on a context or content of the presentation segment, e.g., a type, context and/or content of one or more building blocks included in the presentation segment. For example, in a real estate presentation, application may identify that a “room scene” relates to a kitchen, e.g., based on text entered by user 103 when specifying the kitchen building block. Application 160 may incorporate into the identified scene one or more ads relating to the kitchen, e.g., an ad of a kitchen-appliance retailer, an ad of a carpenter specializing in building kitchens, and the like.

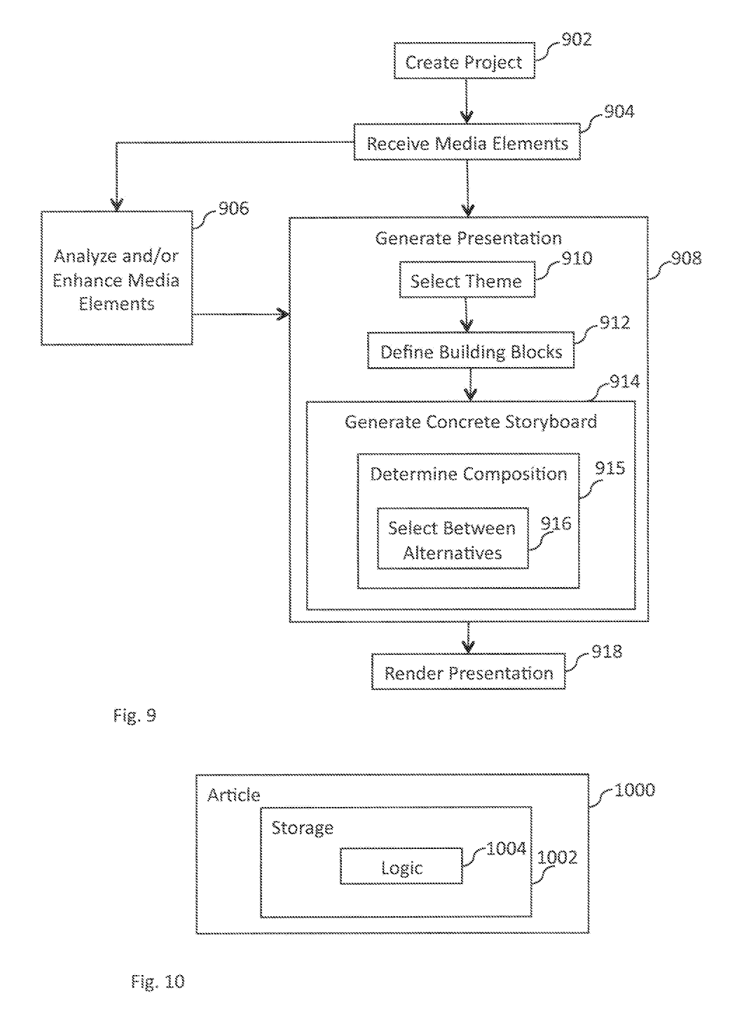

Reference is now made to FIG. 9, which schematically illustrates a method of generating a multimedia presentation, in accordance with some demonstrative embodiments. In some embodiments, one or more of the operations of FIG. 9 may be performed by a system e.g., system 100 (FIG. 1), a presentation generator application, e.g., application 160 (FIG. 1), and/or any other system and/or component.

As indicated at block 902, the method may include creating a new presentation project for generating a new multimedia presentation. For example, user 103 (FIG. 1) may interact with presentation generation application 160 (FIG. 1), e.g., via interface 110 (FIG. 1), to create a new presentation project 181 (FIG. 1) for generating multimedia presentation 171 (FIG. 1), as described above.

As indicated at block 904, the method may include receiving a plurality of input media elements to be included in the multimedia presentation. For example, user 103 (FIG. 1) may provide multimedia elements 169 (FIG. 1) to be utilized by presentation generation application 160 (FIG. 1) for generating presentation 171 (FIG. 1).

As indicated at block 906, the method may include analyzing one or more of the media elements. For example, presentation generation application 160 (FIG. 1) may analyze one or more of media elements 169 (FIG. 1), e.g., as described above.

As indicated at block 908 the method may include generating a multimedia presentation, e.g., a customized presentation, based on the multimedia elements. For example, presentation generation application 160 (FIG. 1) may generate presentation 171 (FIG. 1) based on media elements 169 (FIG. 1), e.g., as described above.

As indicated at block 910, the method may include selecting a presentation theme to be used for generating the multimedia presentation. For example, interface 111 (FIG. 1) may allow user 103 (FIG. 1) to select theme 175 (FIG. 1), e.g., from themes 179 (FIG. 1), as described above.

As indicated at block 912, the method may include associating between the multimedia elements and one or more predefined presentation building blocks. For example, interface 111 (FIG. 1) may allow user 103 (FIG. 1) to define building blocks 158 (FIG. 1) and/or associate media elements 169 (FIG. 1) with building blocks 158 (FIG. 1), e.g., as described above.

As indicated at block 914, the method may include generating a concrete storyboard based on the building blocks, for example, by customizing a dynamic storyboard. For example, application 160 (FIG. 1) may generate concrete storyboard 174 (FIG. 1) based on dynamic storyboard 173 (FIG. 1), building blocks 158 and/or media elements 169 (FIG. 1), e.g., as described above.

As indicated at block 915, the method may include determining a composition, e.g., a time-based composition and/or a graphic-based composition, of one or more presentation segments of the presentation. For example, application 160 (FIG. 1) may determine the composition of one or more presentation segments based on dynamic storyboard 173 (FIG. 1), e.g., as described above.

As indicated at block 916, determining the composition of a presentation segment may include selecting between composition alternatives. For example, application 160 (FIG. 1) may select between one or more composition alternatives 154 (FIG. 1) based on one or more inclusion functions and/or score functions, e.g., as described above.

In one example, the presentation may include a composition alternative for a presentation segment describing features of a product, e.g., a camera, to be sold, e.g., composition alternative 602 of FIG. 6A. Composition 602 (FIG. 6A) may be defined to include a graphical box to display video segments related to a key feature of the product and a text box to display textual information elements related to the feature. The text elements may be defined with a 4 seconds minimum duration for display and 2 seconds for entrance and exit effects for each text segment, e.g., such that the text elements replace one another. The entire text box display may be timely attached to the beginning of the presentation segment and to the end of the presentation segment, such that the text elements are to be displayed for the entire duration of the presentation segment. The video box is defined with a minimum duration for display of 4 seconds. Each video to be included in the box is defined with a minimum duration of 3 seconds and maximum duration of 10 seconds. In case of more than one video, the videos are to replace one another with a fade effect of one second duration. The video box is timely attached to the text box display, starting 1 second after the first text entrance effect is over and ends 1 second before the last text element exit effect starts. User 103 (FIG. 1) may specify 2 text elements for a “key feature zoom magnification capabilities”, for example, a text element “18-15 MM Zoom lens”, and a text element “Better than most SLR cameras”. User 103 (FIG. 1) may also attach one video element having the duration of 8 seconds, showing the zooming in over the camera including a zoom-in relevant segment of 4 seconds. Application 160 (FIG. 1) may position the text elements over the timeline. Each text element requires a display duration of 8 seconds, e.g., 2 seconds for the entrance effect, four seconds for display and two seconds for the exit effect. Accordingly, the total composition alternative duration after the positioning of the text elements is 16 seconds. Application 160 (FIG. 1) may proceed to position the video elements. Application 160 (FIG. 1) may select the most relevant-best quality segments. Accordingly, application 160 (FIG. 1) may begin by incorporating the relevant zoom-in segment of four seconds. However, because the video box duration is attached to the duration of the display of the text elements, the required duration for the video element is 10 seconds, e.g., starting one second after the end of the first text entrance effect and ending one second before the starting of the last text exit effect. Application 160 (FIG. 1) may extend the duration of the video element, for example, by including the entire video segment of eight seconds, extracting a representative image from the video and animating a zoom-in\out over the extracted image for two seconds, repeating the zoom-in segments, and/or any combination thereof, e.g., based on quality of the video segment and\or a predefined priority of the extension solutions.

As indicated at block 918, the method may include rendering the multimedia presentation. For example, application 160 (FIG. 1) may render presentation 171 (FIG. 1) based on concrete storyboard 174 (FIG. 1), e.g., as described above.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Reference is made to FIG. 10, which schematically illustrates an article of manufacture 1000, in accordance with some demonstrative embodiments. Article 1000 may include a machine-readable storage medium 1002 to store logic 1004, which may be used, for example, to perform at least part of the functionality of application 160 (FIG. 1) and/or user interface 111 (FIG. 1); and/or to perform one or more operations of the method of FIG. 8 and/or the method of FIG. 9.

In some demonstrative embodiments, article 1000 and/or machine-readable storage medium 1002 may include one or more types of computer-readable storage media capable of storing data, including volatile memory, non-volatile memory, removable or non-removable memory, erasable or non-erasable memory, writeable or re-writeable memory, and the like. For example, machine-readable storage medium 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 1004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 1004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A system comprising:
a memory having stored thereon application instructions; and
a processor to execute the application instructions resulting in a presentation-generation application able to receive a plurality of input media elements and to generate a multimedia presentation including at least one presentation segment presenting a plurality of presentation media elements corresponding to the input media elements,
wherein a time-based composition of the presentation media elements within the presentation segment is based at least on one or more of the input media elements.

2. The system of claim 1, wherein two or more of the presentation media elements are presented within the presentation segment at least partially simultaneously.

3. The system of claim 1, wherein the plurality of presentation media elements include at least first and second presentation media elements, and wherein one or more time-based presentation parameters for presenting the second presentation media element is based on one or more time-based presentation parameters for presenting the first presentation media element.

4. The system of claim 1, wherein the presentation-generation application is able to determine the time-based composition of the presentation media elements by determining one or more time-based presentation parameters for presenting a presentation media element of the presentation media elements.

5. The system of claim 4, wherein time-based parameters include at least one of a duration of the presentation media element, a beginning time of presenting the presentation media element and an end time of presenting the presentation media element.

6. The system of claim 4, wherein the presentation media element includes at least a portion of at least one input media element of the input media elements, and wherein the presentation-generation application is able to adjust the portion of the input media element included within the presentation media element based on the time-based presentation parameters.

7. The system of claim 4, the presentation-generation application is able to exclude at least a portion of at least one of the input media elements from the presentation.

8. The system of claim 1, wherein the presentation media elements include a plurality of media elements associated with a common predefined building block.

9. The system of claim 8, wherein the plurality of presentation media elements includes a first media element, which includes at least one of a video and an image, and a second media element including a text element relating to a content of the first media element.

10. The system of claim 1, wherein the presentation-generation application is able to associate the input media elements with a plurality of predefined presentation building-blocks based on input information corresponding to the input media elements, and wherein the presentation-generation application is able to determine presentation media elements to be included in the presentation segment based on the presentation building blocks.

11. The system of claim 1, wherein the presentation-generation application is able to define the presentation segment based on a predefined composition, which defines one or more parameters of the time-based composition.

12. The system of claim 11, wherein the presentation-generation application is able to select the composition from a plurality of predefined composition alternatives.

13. The system of claim 1, wherein the presentation-generation application is able to determine the time-based composition based on at least one of a quality of at least one of the input media elements, a duration of at least one of the input media elements, a content of at least one of the input media elements, an association between two or more of the input media elements, a type of media included in one or more of the input media elements, and input information corresponding to the input media elements.

14. The system of claim 1, wherein the presentation-generation application is able to receive from a user an indication of a presentation theme selected from a predefined set of presentation themes, and to define the time-based composition based on the selected theme.

15. The system of claim 1, wherein the presentation-generation application is able to determine, based on one or more of the input media elements, at least one of a duration of the presentation segment, a graphical composition of the presentation segment, a number of the presentation media elements included in the presentation segment, and a relative placement of the presentation media elements included in the presentation segment.

16. The system of claim 1, wherein the at least one presentation segment includes a sequence of a plurality of presentation segments including two or more presentation segments having different compositions.

17. The system of claim 1, wherein the presentation-generation application is able to generate the presentation segment including one or more advertisements, which include advertisement content corresponding to a content of at least one of the presentation media elements.

18. The system of claim 1, wherein the presentation media elements include at least one of a video element, an audio element, an image element, and a text element.

19. A computer-based method of customized video, the method comprising:
receiving, by a computing device, a plurality of input media elements;
associating between the plurality of input media elements and a plurality of predefined presentation building-blocks; and
generating, by the computing device, a multimedia presentation including a sequence of presentation segments,
wherein a presentation segment of the sequence of presentation segments includes at least one presentation media element corresponding to at least one building block,
and wherein the at least one presentation media element includes at least a portion of at least one input media element of the media elements associated with the at least one building block.

20. The method of claim 19, wherein associating between the plurality of input media elements and the plurality of predefined presentation building blocks includes associating between the plurality of input media elements and the plurality of predefined building blocks based on input information corresponding to the input media elements.

21. The method of claim 19, wherein generating the multimedia presentation includes automatically determining a composition of the presentation segment based on the input media elements associated with the building block.

22. The method of claim 21, wherein determining the composition of the presentation segment includes determining a time-based composition of the at least one presentation media element.

23. The method of claim 22, wherein determining the time-based composition includes determining the time-based composition based on at least one of a quality of at least one of the media elements associated with the building block, a duration of at least one of the media elements associated with the building block, a content of at least one of the media elements associated with the building block, a type of media included in at least one of the media elements associated with the building block, and input from a user.

24. The method of claim 19, wherein the presentation building blocks are defined according to a presentation theme selected from a plurality of predefined presentation themes.

25. The method of claim 19, wherein the sequence of presentation segments includes at least first and second presentation segments, which are based on a common predefined composition, and wherein the first presentation segment includes one or more presentation elements, which are not included in the second presentation element.

26. The method of claim 19 including composing the presentation segment based on a presentation composition, which is selected from a plurality of predefined presentation composition alternatives.

27. The method of claim 19 including determining, based on the at least one input media element associated with the building block, at least one of a duration of the presentation segment, a graphical composition of the presentation segment, a number of presentation media elements included in the presentation segment, and a relative placement of the presentation media elements to be included in the presentation segment.

28. The method of claim 19 including generating the presentation segment including one or more advertisements, which include advertisement content corresponding to a content of at least one of the presentation media elements.

29. The method of claim 19, wherein the presentation media elements include at least one of a video element, an audio element, an image element, and a text element.
